(19) United States
(12) Patent Application Publication
(10) Pub. No.: US 2026/0012644 A1
(43) Pub. Date: Jan. 8, 2026

(54) 3D DATA DECODING APPARATUS AND 3D DATA ENCODING APPARATUS

(71) Applicant: SHARP KABUSHIKI KAISHA, Sakai City (JP)

(72) Inventors: Sujun HONG, Sakai City (JP); YASUAKI TOKUMO, Sakai City (JP); TOMOHIRO IKAI, Sakai City (JP)

(21) Appl. No.: 19/053,717

(22) Filed: Feb. 14, 2025

(30) Foreign Application Priority Data
Jul. 5, 2024 (JP) 2024-108650

(51) Int. Cl. H04N 19/70; H04N 19/136; H04N 19/167

(52) U.S. Cl. CPC H04N 19/70; H04N 19/136; H04N 19/167

(57) ABSTRACT

The object is to encode and decode 3D data not having redundancy with high efficiency with maintained flexibility in definition of a tile by indicating similarities/differences between atlas tile information and attribute tile information.

Solution

A 3D data decoding apparatus for decoding mesh data or point cloud data includes a tile information decoder configured to decode atlas tile information from encoded data in which the mesh data or the point cloud data is encoded, and an extension information decoder configured to decode extension control parameter information from the encoded data. The extension control parameter information includes attribute tile information. At the extension information decoder, a flag indicating a similarity/difference between the (atlas) tile information and the attribute tile information is decoded from the encoded data, and derives the attribute tile information.

### TECHNICAL FIELD

Embodiments of the present invention relate to a 3D data encoding apparatus and a 3D data decoding apparatus.

### BACKGROUND ART

A 3D data encoding apparatus that converts 3D data into a two-dimensional image and encodes it using a video encoding scheme to generate encoded data and a 3D data decoding apparatus that decodes a two-dimensional image from the encoded data to reconstruct 3D data are provided to efficiently transmit or record 3D data.

Specific 3D data encoding schemes include, for example, MPEG-I ISO/IEC 23090-5 Visual Volumetric Video-based Coding (V3C) and Video-based Point Cloud Compression (V-PCC). V3C can encode and decode a point cloud including point positions and attribute information. V3C is also used to encode and decode multi-view videos and mesh videos through ISO/IEC 23090-12 (MPEG Immersive Video (MIV)) and ISO/IEC 23090-29 (Video-based Dynamic Mesh Coding (V-DMC)) that is currently being standardized. A latest draft document of the V-DMC scheme is disclosed in NPL 1.

In such 3D data encoding schemes, geometries and attributes that constitute 3D data are encoded and decoded as images using a video encoding scheme such as H.265/HEVC (High Efficiency Video Coding) or H.266/VVC (Versatile Video Coding).

In the case of a point cloud, a geometry image is an image corresponding to depths to the projection plane and an attribute image is an image of attributes projected onto the projection plane.

The 3D data (mesh) as described in NPL 1 includes a base mesh, a mesh displacement, and a texture-mapped image. A vertex encoding scheme such as Draco can be used for encoding the base mesh. Methods for encoding the mesh displacement include direct encoding by arithmetic encoding, in addition to a method of using a video codec to encode a mesh displacement image obtained by two-dimensionally converting the mesh displacement. The texture-mapped image is encoded as an attribute image by a video codec. As a video codec, the above-described HEVC and VVC can be used.

### CITATION LIST

### Non Patent Literature

### NPL 1

Text of ISO/IEC CD 23090-29 Video-based mesh coding, ISO/IEC JTC 1/SC 29/WG 7 N0885, April 2024

### SUMMARY OF INVENTION

### Technical Problem

The 3D data encoding scheme in NPL 1 has a problem in that, although each of atlas tile information and attribute tile information can be encoded and decoded, the atlas tile information and the attribute tile information have redundancy, which makes encoding inefficient.

The present invention has an object to encode and decode 3D data not having redundancy with high efficiency with maintained flexibility in definition of a tile by indicating similarities/differences between atlas tile information and attribute tile information.

### Solution to Problem

A 3D data decoding apparatus for decoding mesh data or point cloud data includes a tile information decoder configured to decode atlas tile information from encoded data in which the mesh data or the point cloud data is encoded, and an extension information decoder configured to decode extension control parameter information from the encoded data. The extension control parameter information includes attribute tile information. At the extension information decoder, a flag indicating a similarity/difference between the (atlas) tile information and the attribute tile information is decoded from the encoded data, and derives the attribute tile information.

A 3D data encoding apparatus for encoding mesh data or point cloud data includes an extension information encoder configured to encode extension control parameter information, and a tile information encoder configured to encode (atlas) tile information. The extension control parameter information includes attribute tile information. A flag indicating a similarity/difference between the (atlas) tile information and the attribute tile information encoded in the extension information encoder is encoded.

### Advantageous Effects of Invention

According to an aspect of the present invention, flexibility in definition of a tile can be enhanced, and 3D data can be encoded and decoded with high quality.

### BRIEF DESCRIPTION OF DRAWINGS

FIG. 1 is a schematic diagram illustrating a configuration of a 3D data transmission system according to the present embodiment.

FIG. 2 is a diagram illustrating a hierarchical structure of data of an encoding stream.

FIG. 3 is a functional block diagram illustrating a schematic configuration of a 3D data decoding apparatus 31.

FIG. 4 is a functional block diagram illustrating a configuration of an atlas information decoder 302.

FIG. 5 is a functional block diagram illustrating a configuration of a base mesh decoder 303.

FIG. 6 is a functional block diagram illustrating a configuration of a mesh displacement decoder 305.

FIG. 7 is a functional block diagram illustrating a configuration of a mesh reconstructor 307.

FIG. 8 is an example of syntax of ASPS Vdmc Extension (ASVE) being a sequence-level mesh data extension encoding parameter set.

FIG. 9 is an example of syntax of extension encoding parameter information in an AFPS being a picture/frame-level parameter set.

FIG. 10 is an example of syntax of atlas tile information in an atlas frame.

FIG. 11 is an example of syntax of attribute tile information in an atlas frame.

FIG. 12 is a diagram for illustrating operation of the mesh reconstructor 307.

FIG. 13 is a functional block diagram illustrating a schematic configuration of a 3D data encoding apparatus 11.

FIG. 14 is a functional block diagram illustrating a configuration of an atlas information encoder 101.

FIG. 15 is a functional block diagram illustrating a configuration of a base mesh encoder 103.

FIG. 16 is a functional block diagram illustrating a configuration of a mesh displacement encoder 107.

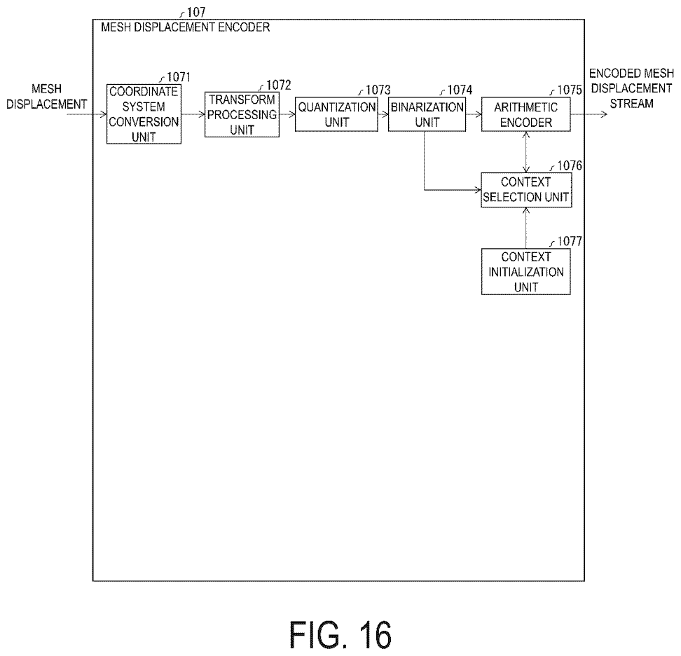

FIG. 17 is a functional block diagram illustrating a configuration of a mesh separator 115.

FIG. 18 is a diagram for illustrating operation of the mesh separator 115.

FIG. 19 is a diagram illustrating positions of tiles.

FIG. 20 is a diagram illustrating positions of tiles.

FIG. 21 is a diagram illustrating positions of tiles.

### DESCRIPTION OF EMBODIMENTS

Embodiments of the present invention will be described below with reference to the drawings.

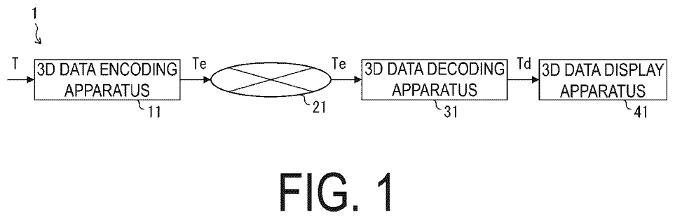

FIG. 1 is a schematic diagram illustrating a configuration of a 3D data transmission system 1 according to the present embodiment.

The 3D data transmission system 1 is a system that transmits an encoding stream obtained by encoding 3D data to be encoded, decodes the transmitted encoding stream, and displays 3D data. The 3D data transmission system 1 includes a 3D data encoding apparatus 11, a network 21, a 3D data decoding apparatus 31, and a 3D data display apparatus 41. 3D data T is input to the 3D data encoding apparatus 11.

The network 21 transmits an encoding stream Te generated by the 3D data encoding apparatus 11 to the 3D data decoding apparatus 31. The network 21 is the Internet, a Wide Area Network (WAN), a Local Area Network (LAN), or a combination thereof. The network 21 is not limited to a bidirectional communication network and may be a unidirectional communication network that transmits broadcast waves for terrestrial digital broadcasting, satellite broadcasting, or the like. The network 21 may be replaced by a storage medium on which the encoding stream Te is recorded, such as a Digital Versatile Disc (DVD) (trade name) or a Blu-ray Disc (BD) (trade name).

The 3D data decoding apparatus 31 decodes each encoding stream Te transmitted by the network 21 and generates one or more pieces of decoded 3D data Td.

The 3D data display apparatus 41 displays all or some of one or more pieces of decoded 3D data Td generated by the 3D data decoding apparatus 31. The 3D data display apparatus 41 includes a display apparatus such as, for example, a liquid crystal display or an organic electro-luminescence (EL) display. Examples of display types include stationary, mobile, and HMD. The 3D data display apparatus 41 displays a high quality image in a case that the 3D data decoding apparatus 31 has high processing capacity and displays an image that does not require high processing or display capacity in a case that it has only lower processing capacity.

### Operators

Operators used in the present specification will be described below.

“>>” is a right bit shift, “<<” is a left bit shift, “&” is a bitwise AND, “|” is a bitwise OR, “|=” is an OR assignment operator, and “∥” indicates a logical sum.

x?y: z is a ternary operator that takes y in a case that x is true (other than 0) and takes z in a case that x is false (0).

“y . . . z” indicates a set of integers from y to z.

Log2(x) is logarithm of x to base 2.

Ceil(x) is a minimum integer greater than or equal to x.

Floor(x) is a maximum integer less than or equal to x.

Sign(x) is the sign of x. It is 1 in a case that x is equal to or greater than 0, and is −1 in a case that x is less than 0.

Abs (x) is an absolute value of x.

Round (x) is an integer obtained by rounding x off to the first decimal place. Sign(x)*Floor(Abs(x)+0.5).

/ is integer division for truncating toward 0. For example, 7/4 is truncated to 1, and − 7/4 is truncated to −1.

+is division in which truncation or rounding is not performed.

### Structure of Encoding Stream Te

Prior to a detailed description of a 3D data encoding apparatus 11 and a 3D data decoding apparatus 31 according to the present embodiment, a data structure of the encoding stream Te generated by the 3D data encoding apparatus 11 and decoded by the 3D data decoding apparatus 31 will be described. 3D data may be MPEG-I ISO/IEC 23090-5 Volumetric Video-based Coding (V3C) and Video-based Point Cloud Compression (V-PCC), and V3D-based ISO/IEC 23090-12 (MPEG Immersive Video (MIV)) and ISO/IEC 23090-29 (Video-based Dynamic Mesh Coding (V-DMC)).

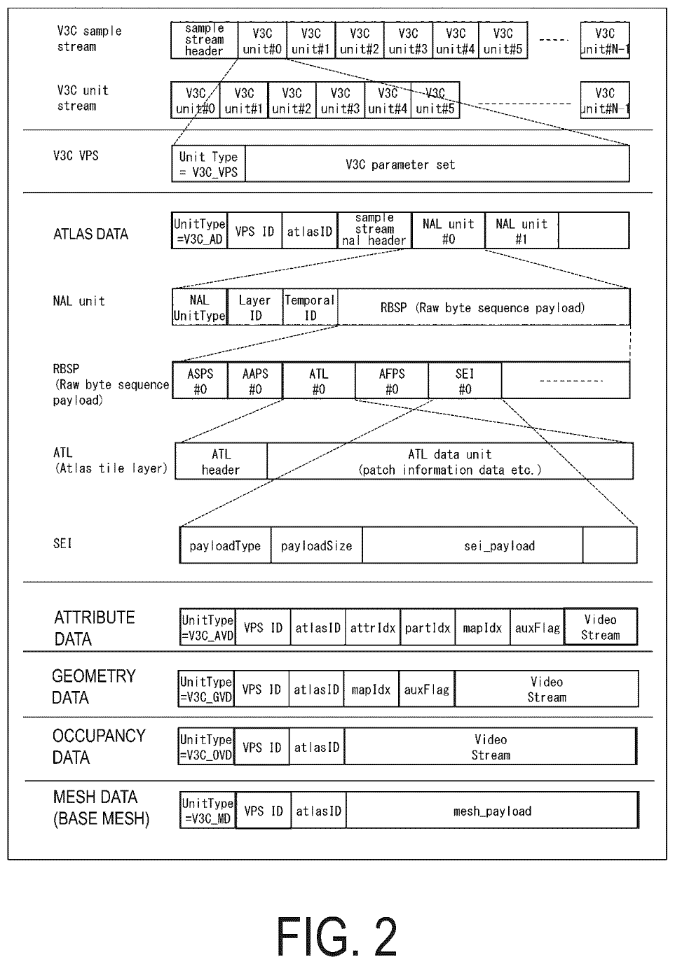

FIG. 2 is a diagram illustrating a hierarchical structure of data of the encoding stream Te. The encoding stream Te has a data structure of either a V3C sample stream or a V3C unit stream. A V3C sample stream includes a sample stream header and V3C units. The V3C unit stream includes a V3C unit.

Each V3C unit includes a V3C unit header and a V3C unit payload. The V3C unit header is a Unit Type that is an ID indicating the type of the V3C unit, and takes a value indicated by a label such as V3C_VPS, V3C_AD, V3C_AVD, V3C_GVD, or V3C_OVD.

In a case that the Unit Type is a V3C_VPS (Video Parameter Set), the V3C unit includes a V3C parameter set.

In a case that the Unit Type is V3C_AD (Atlas Data), the V3C unit includes a VPS ID, an atlasID, a sample stream nal header, and multiple NAL units. The atlasID is Identification (ID) and takes an integer value of 0 or more.

Each NAL unit includes a NALUnitType, a layerID, a TemporalID, and a Raw Byte Sequence Payload (RBSP).

A NAL unit is identified by NALUnitType and includes an Atlas Sequence Parameter Set (ASPS), an Atlas Adaptation Parameter Set (AAPS), an Atlas Tile Layer (ATL), Supplemental Enhancement Information (SEI), and the like.

The ATL includes an ATL header and an ATL data unit and the ATL data unit includes information on positions and sizes of patches or the like such as patch information data.

The SEI includes a payloadType indicating the type of the SEI, a payloadSize indicating the size (number of bytes) of the SEI, and an sei_payload which is data of the SEI.

In a case that the Unit Type is V3C_AVD (Attribute Video Data, attribute data), the V3C unit includes a VPS ID, an atlasID, an attrIdx which is an attribute image ID, a partIdx which is a partition ID, a mapIdx which is a map ID, a flag auxFlag indicating whether the data is Auxiliary data, and a video stream. The video stream is data encoded by HEVC, VVC, or the like. The attribute data corresponds to a texture image in the V-DMC. attrIdx may be an integer from 0 to ai_attribute_count [RecAtlasID]−1. Here, ai_attribute_count is a syntax element of attribute_information, and RecAtlasID is a target atlas ID (atlasID).

Here, ai_attribute_count[j] indicates the number of attributes associated with the atlas of the atlas ID having index j. In a case of not being present, the value of ai_attribute_count[j] is inferred to be 0.

In a case that the NalUnitType is V3C_GVD (Geometry Video Data, geometry data), the V3C unit includes a VPS ID, an atlasID, a mapIdx, an auxFlag, and a video stream. The geometry data corresponds to mesh displacements in the V-DMC.

In a case that the Unit Type is V3C_OVD (Occupancy Video Data, occupancy data), the V3C unit includes the VPS ID, atlasID, and the video stream.

In a case that the Unit Type is V3C_MD (Mesh Data), the V3C unit includes a VPS ID, an atlasID, and a mesh_payload. In V-DMC, this corresponds to a base mesh.

### Configuration of 3D Data Decoding Apparatus According to First Embodiment

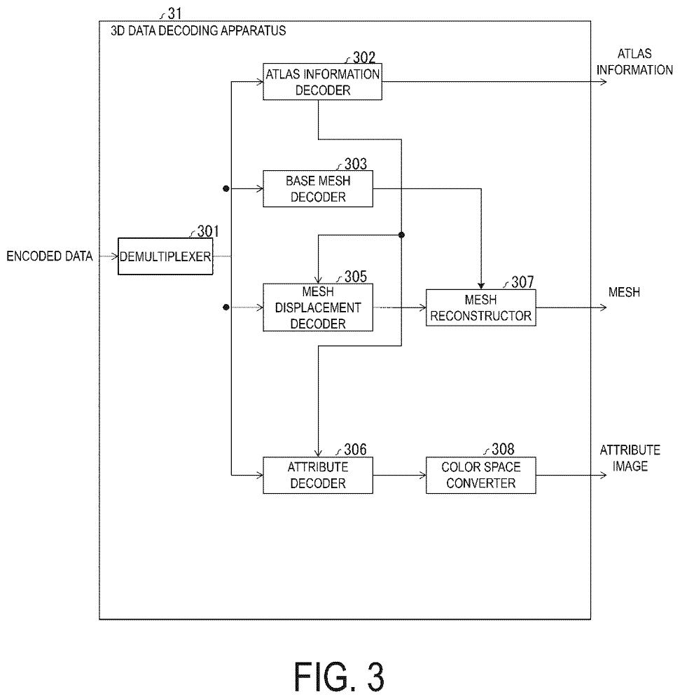

FIG. 3 is a functional block diagram illustrating a schematic configuration of the 3D data decoding apparatus 31 according to a first embodiment. The 3D data decoding apparatus 31 includes a demultiplexer 301, an atlas information decoder 302, a base mesh decoder 303, a mesh displacement decoder 305, a mesh reconstructor 307, an attribute decoder 306, and a color space converter 308. The 3D data decoding apparatus 31 receives encoded data of 3D data and outputs atlas information, mesh, and an attribute image.

The demultiplexer 301 receives encoded data multiplexed in a byte stream format, an ISOBMFF (ISO Base Media File Format), or the like and demultiplexes it and outputs an encoded atlas information stream (an Atlas Data stream of V3C_AD and NALunits), an encoded base mesh stream (a mesh_payload of V3C_MD), an encoded mesh displacement stream (a video stream of V3C_GVD), and an attribute video stream (a video stream of V3C_AVD).

The atlas information decoder 302 receives the encoded atlas information stream output from the demultiplexer 301 and decodes atlas information.

The atlas information decoder 302 of FIG. 3 decodes coordinate system conversion information displacementCoordinateSystem (asve_displacement_coordinate_system, afve_displacement_coordinate_system) indicating a coordinate system from encoded data. Note that a gating flag may also be provided separately and each piece of coordinate system conversion information may be decoded only in a case that the gating flag is 1. The gating flag is afve_displacement_coordinate_system_enable_flag, for example.

The base mesh decoder 303 decodes an encoded base mesh stream that has been encoded by vertex encoding (a 3D data compression encoding scheme such as, for example, Draco) and outputs a base mesh. The base mesh will be described later. A type of a codec of the base mesh may be obtained by decoding syntax elements bmsps_intra_mesh_codec_id and bmsps_inter_mesh_codec_id.

The mesh displacement decoder 305 decodes a mesh displacement encoding stream and outputs mesh displacements. The type of codec used for encoding is indicated by a ptl_profile_codec_group_idc obtained by decoding the V3C parameter set of encoded data. This may also be indicated by a FourCC code (a four character code or a 4 CC code) indicated by a gi_geometry_codec_id[atlasID] in the V3C parameter set. The gi_geometry_codec_id[atlasID] indicates an index corresponding to the codec ID of a decoder used to decode the geometry video stream in the atlas ID. A syntax element dsps_codec_id indicating the type of the codec may be decoded from the parameter set. A set indicating the correspondence between the codec ID (ccm_codec_id) and its 4CC code (ccm_codec_4cc[ccm_codec_id]) may be transmitted in another codec mapping SEI (component_codec_mapping SEI).

The mesh reconstructor 307 receives the base mesh and mesh displacements and reconstructs a mesh in 3D space.

The attribute decoder 306 decodes an attribute video stream obtained by encoding such as VVC or HEVC, and outputs an attribute image. The attribute image may be a texture image (a texture mapped image obtained by transform by a UV atlas method) expanded on a UV axis and may be in a YCbCr format. The type of codec used for encoding is indicated by a ptl_profile_codec_group_idc obtained by decoding the V3C parameter set of encoded data. It may be indicated by a Four CC code indicated by ai_attribute_codec_id[atlasID] of the V3C parameter set. ai_attribute_codec_id[atlasID] indicates an index corresponding to a codec ID of a decoder used to decode an attribute video stream in the atlas ID.

The color space converter 308 performs color space conversion of the attribute image from a YCbCr format to an RGB format. Note that it is also possible to adopt a configuration in which an attribute video stream encoded in an RGB format is decoded and color space conversion is omitted.

### Decoding of Atlas Information

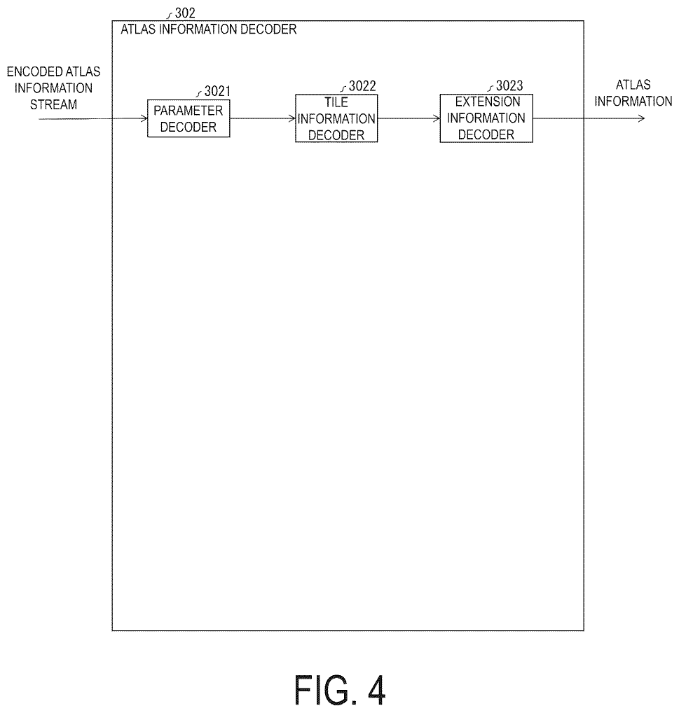

FIG. 4 is a functional block diagram illustrating a configuration of the atlas information decoder 302. The atlas information decoder 302 includes a parameter decoder 3021, a tile information decoder 3022, and an extension information decoder 3023.

### Decoding and Derivation of Encoding Parameters

The parameter decoder 3021 decodes encoding parameters from an encoded atlas information stream. The encoding parameters include an Atlas Sequence Parameter Set (ASPS) being a sequence-level parameter set and an Atlas Frame Parameter Set (AFPS) being a picture/frame-level parameter set.

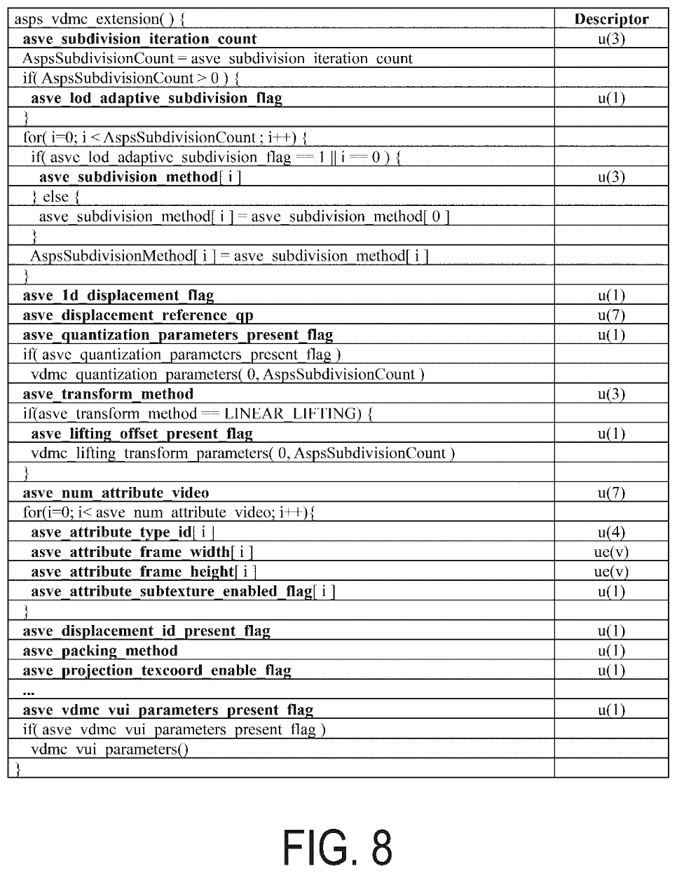

FIG. 8 is an example of syntax of ASPS Vdmc Extension (ASVE) being a sequence-level mesh data extension encoding parameter set. Semantics of each field is as follows. asve_subdivision_iteration_count: it indicates the number of subdivision iterations of the mesh.

asve_Id_displacement_flag: flag indicating whether or not the mesh displacement is one-dimensional. The value being true indicates that the mesh displacement is one-dimensional. The value being false indicates that the mesh displacement is three-dimensional.

asve_num_attribute_video: it indicates the number of attributes signaled via a video sub-bitstream. The value of asve_num_attribute_video being equal to the value of ai_attribute_count[j] is a V3C bitstream conformance requirement.

Decoding and Derivation of Encoding Parameters of Tiles

Atlas tile information (tile selection information, tile division information) being an encoding parameter for defining a tile to be decoded from encoded data in the tile information decoder 3022 will be described. In the V3C standard, picture division (partition division) common to the atlas frame, the occupancy frame, the geometry frame, and the attribute frame can be defined as the tile. Information representing the atlas, the occupancy, the geometry, and the attribute is the atlas, and thus the tile defined here is an atlas tile. Tile information may be referred to as atlas tile information. In a case of defining a specific component, for example, an attribute-dedicated tile, it is referred to as an attribute tile. Note that a unit of a tile has a rectangular shape, and definition of a tile (common to the atlas tile information and the attribute tile information) may include the number of columns and the number of rows of the tile constituting a picture, the width of the tile in a certain column, and the height of the tile in a certain row.

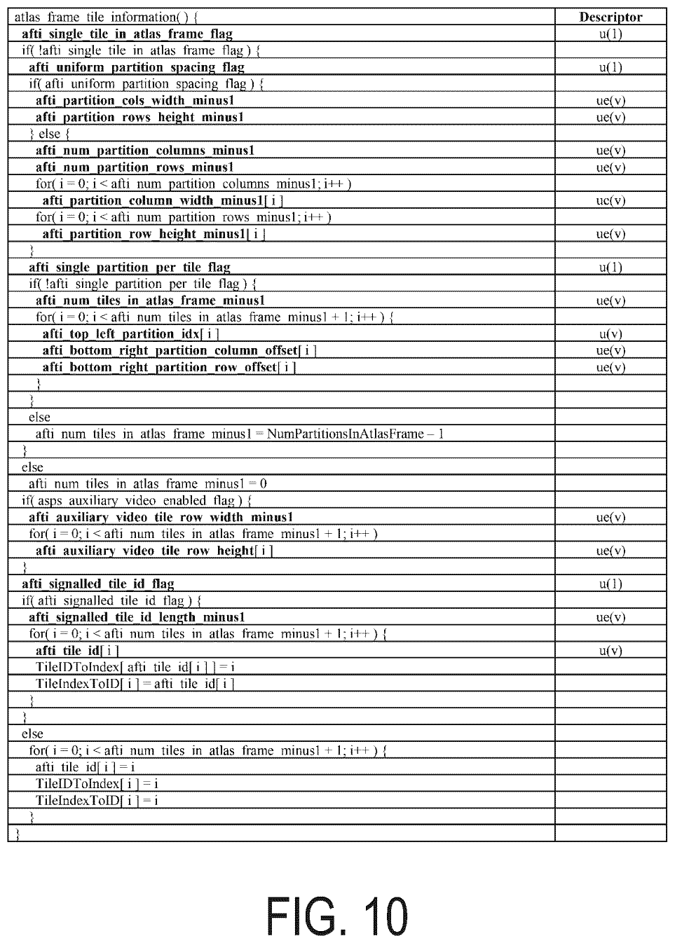

FIG. 10 is an example of syntax of tile information in the atlas frame parameter set (AFPS) being a picture/frame-level parameter set. Semantics of each field is as follows.

afti_single_tile_in_atlas_frame_flag: flag indicating whether or not only one tile is present in each atlas frame referring to the AFPS. In a case that the value is true, it indicates that only one tile is present in each atlas frame referring to the AFPS. In a case that the value is false, multiple (more than one) tiles are present in each atlas frame referring to the AFPS.

afti_single_partition_per_tile_flag: flag indicating whether or not only one tile partition is included in each tile referring to the AFPS. In a case that the value is true, it indicates that only one tile partition is included in each tile referring to the AFPS, and in a case that the value is false, it indicates that multiple (more than one) tile partitions are included in each tile referring to the AFPS. In a case of not being present, the value of afti_single_partition_per_tile_flag is inferred to be equal to 1.

afti_num_tiles_in_atlas_frame_minus1: it indicates the number of tiles of each atlas frame referring to the AFPS. The value of afti_num_tiles_in_atlas_frame_minus1 shall be within a range of 0 to NumPartitionsInAtlasFrame−1. In a case of not being present, and afti_single_partition_per_tile_flag is equal to 1, the value of afti_num_tiles_in_atlas_frame_minus1 is inferred to be equal to NumPartitions InAtlasFrame−1.

afti_signalled_tile_id_flag: flag indicating whether or not the tile ID of each tile is signaled. In a case that the flag is equal to 1, the tile ID of each tile is signaled. In a case that the flag is equal to 0, the tile ID is not signaled.

afti_signalled_tile_id_length_minus1: afti_signalled_tile_id_length_minus1+1 indicates a syntax element afti_tile_id[i] (in a case of being present) in a tile header and the number of bits used to express a syntax element ath_id. The value of afti_signalled_tile_id_length_minus1 shall be within a range of 0 to 15.

afti_tile_id[i]: it indicates the tile ID of the i-th tile. In a case of not being present, the value of afti_tile_id[i] is inferred to be equal to i for each i within a range of 0 to afti_num_tiles_in_atlas_frame_minus1. afti_tile_id[i] not being equal to afti_tile_id[j] (a case of being equal thereto shall not be present) for all of i!=j is a bitstream conformance requirement. The 3D data decoding apparatus 31 decodes a bitstream satisfying the conformance requirement (the same applies hereinafter).

In a case of decoding and encoding afti_single_tile_in_atlas_frame_flag and afti_single_partition_per_tile_flag, the tile information decoder 3022 may decode and encode a syntax element afti_num_tiles_in_atlas_frame_minus2 indicating the number of tiles minus 2 (a value obtained by subtracting 2 from the number of tiles). Alternatively, only in a case that the value of afti_single_tile_in_atlas_frame_flag is false and the value of afti_single_partition_per_tile_flag is false, the syntax element afti_num_tiles_in_atlas_frame_minus2 indicating the number of tiles to be referred to minus 2 may be decoded and encoded. The following example may be used for semantics.

afti_num_tiles_in_atlas_frame_minus2: it indicates the number of tiles of each atlas frame referring to the atlas frame parameter set AFPS. The value of afti_num_tiles_in_atlas_frame_minus1 shall be within a range of 0 to NumPartitionsInAtlasFrame−2. In a case of not being present, and afti_single_partition_per_tile_flag is equal to 1, the value of afti_num_tiles_in_atlas_frame_minus2 is inferred to be equal to NumPartitionsInAtlasFrame−2.

In the present configuration, a case that the number of tiles to be referred to is one can be expressed by afti_single_tile_in_atlas_frame_flag, and thus there is an effect that overhead for the amount of codes can be reduced by decoding and encoding the syntax element indicating the number of tiles minus 2.

### Decoding and Derivation of Extension Encoding Parameters

Extension encoding parameters to be decoded from encoded data in the extension information decoder 3023 will be described.

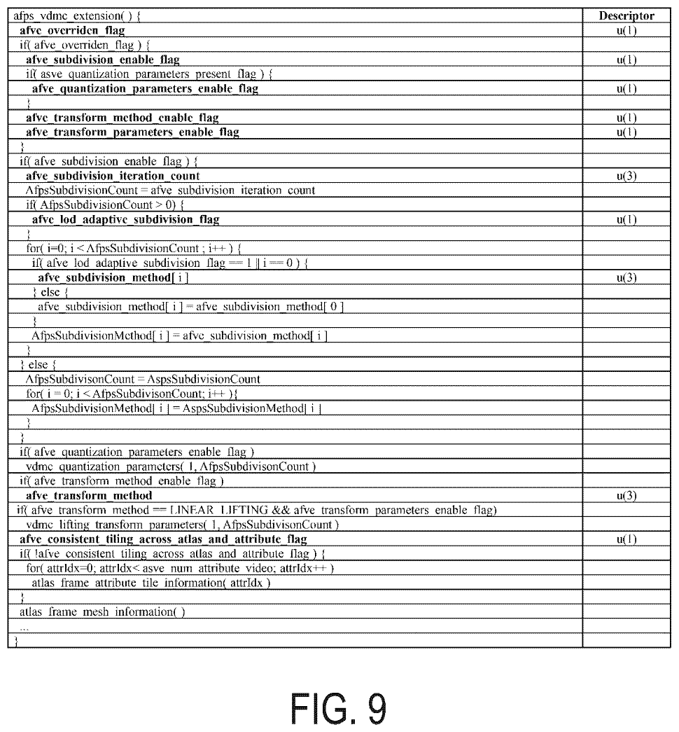

FIG. 9 is an example of syntax of extension encoding parameter information in the AFPS being a picture/frame-level parameter set.

afve_overriden_flag: flag indicating whether or not the coordinate system for mesh displacements is updated. In a case that the flag is equal to true, the coordinate system for mesh displacements is updated based on the value of mdu_displacement_coordinate_system to be described later. In a case that the flag is equal to false, the coordinate system for mesh displacements is not updated.

afve_subdivision_iteration_count: it indicates the number of subdivision iterations of the mesh.

### Decoding and Derivation of Attribute Tile-Level Encoding Parameters

“Definition of a tile for each attribute (attribute tile information)” being attribute tile-level encoding parameters to be decoded from encoded data in the extension information decoder 3023 will be described. In the V3C standard, although partition division common to pieces of data is defined as the atlas tile, partition division applied only to attribute data may be present. Such a tile is referred to as an “attribute tile”, and definition of the tile is referred to as “attribute tile information”. Syntax elements and parameters of the attribute tile information are basically similar to those of the atlas tile information; however, differences lie in that an application target is limited to an attribute and encoding and decoding are performed for each attribute (each attrIdx).

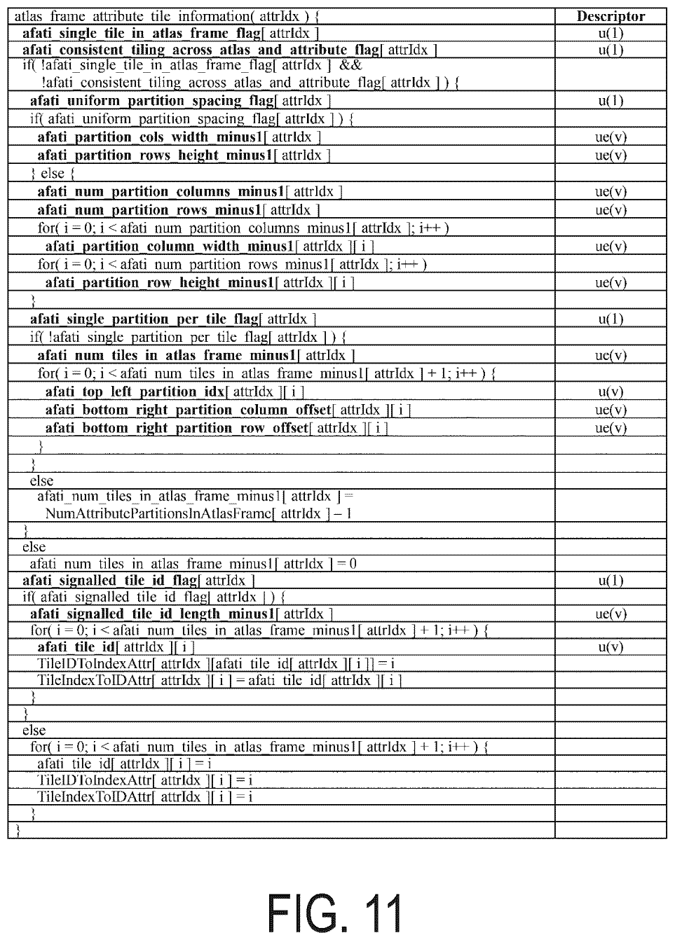

FIG. 11 is an example of syntax of attribute tile information encoding parameters in the AFPS being a picture/frame-level parameter set.

afati_single_tile_in_atlas_frame_flag[attrIdx]: in a case that afati_single_tile_in_atlas_frame_flag[attrIdx] is equal to 1, it indicates that the number of tiles of the attribute, signaled for each piece of attribute video data, having the index attrIdx is only one. In a case that afati_single_tile_in_atlas_frame_flag[attrIdx] is equal to 0, it indicates that the number of tiles of the attribute, signaled for each piece of attribute video data, having the index attrIdx is two or more.

afati_uniform_partition_spacing_flag[attrIdx]: in a case that afati_uniform_partition_spacing_flag[attrIdx] is equal to 1, it indicates that tile division of the atlas for the attribute, signaled for each piece of attribute video data, having the index attrIdx uses a method of uniformly dividing boundaries of columns and rows across the attribute atlas frame. Information corresponding to these boundaries is signaled using syntax elements afati_partition_cols_width_minus 1[attrIdx] and afati_partition_rows_height_minus 1[attrIdx], respectively. In a case that afati_uniform_partition_spacing_flag[attrIdx] is equal to 0, it indicates that tile division of the atlas for the attribute, signaled for each piece of attribute video data, having the index attrIdx uses a method that (may) result(s) in boundaries of columns and rows that are (may be) uniformly divided across the atlas frame. In this case, these boundaries are signaled using a list of syntax elements afati_num_partition_columns_minus1[attrIdx] and afati_num_partition_rows_minus1[attrIdx] and syntax elements afati_partition_column_width_minus 1[attrIdx][i] and afati_partition_row_height_minus 1[attrIdx][i]. In a case of not being present, the value of afati_ti_uniform_partition_spacing_flag[attrIdx] is inferred to be equal to 1.

afati_partition_cols_width_minus 1[attrIdx]: in a case that afati_uniform_partition_spacing_flag[attrIdx] is equal to 1, the value obtained by adding 1 to afati_partition_cols_width_minus1 [attrIdx] indicates the width of the attribute tile partition column (width of the column of the tile) in an attribute video data unit having the index attrIdx except the attribute tile partition column on the right edge of the attribute atlas frame in units of 64 samples. The value of afati_partition_cols_width_minus 1[attrIdx] is within a range of 0 to asve_attribute_frame_width[attrIdx]/64−1. In a case of not being present, the value of afati_partition_cols_width_minus 1 [attrIdx] is inferred to be equal to asve_attribute_frame_width[attrIdx]/64−1.

afati_partition_rows_height_minus1[attrIdx]: in a case that afati_uniform_partition_spacing_flag[attrIdx] is equal to 1, the value obtained by adding 1 to afati_partition_rows_height_minus1[attrIdx] indicates the height of the attribute tile partition row, for each piece of attribute video data, having the index attrIdx except the bottommost attribute tile partition row of the attribute atlas frame in units of 64 samples. The value of afati_partition_rows_height_minus1[attrIdx] is within a range of 0 to asve_attribute_frame_height[attrIdx]/64−1. In a case of not being present, the value of afati_partition_rows_height_minus1 [attrIdx] is inferred to be equal to asve_attribute_frame_height[attrIdx]/64−1.

afati_num_partition_columns_minus 1[attrIdx]: in a case that afati_uniform_partition_spacing_flag[attrIdx] is equal to 0, the value obtained by adding 1 to afati_num_partition_columns_minus1[attrIdx] indicates the number of attribute tile partition columns in the attribute video data having the index attrIdx to be used to divide the attribute atlas frame. The value of afati_num_partition_columns_minus1[attrIdx] is within a range of 0 to asve_attribute_frame_width[attrIdx]/64−1. In a case that afati_single_tile_in_atlas_frame_flag[attrIdx] is 1, the value of afati_num_partition_columns_minus1[attrIdx] is inferred to be equal to 0.

afati_num_partition_rows_minus1[attrIdx]: in a case that afati_uniform_partition_spacing_flag[attrIdx] is equal to 0, the value obtained by adding 1 to afati_num_partition_rows_minus1[attrIdx] indicates the number of attribute tile partition rows in the attribute video data having the index attrIdx to be used to divide the attribute atlas frame. The value of afati_num_partition_rows_minus1 [attrIdx] is within a range of 0 to asve_attribute_frame_height [attrIdx]/64−1. In a case that afati_single_tile_in_atlas_frame_flag[attrIdx] is 1, the value of afati_num_partition_rows_minus1[attrIdx] is inferred to be equal to 0.

afati_partition_column_width_minus1[attrIdx][i]: value obtained by adding 1 to afati_partition_column_width_minus1[attrIdx][i] indicates the width of the i-th attribute tile partition column of the attribute video data having the index attrIdx in units of 64 samples.

afati_partition_row_height_minus1[attrIdx][i]: value obtained by adding 1 to afati_partition_row_height_minus1[attrIdx][i] indicates the height of the i-th attribute tile partition row of the attribute video data having the index attrIdx in units of 64 samples.

afati_single_partition_per_tile_flag[attrIdx][i]: in a case that afati_single_partition_per_tile_flag[attrIdx] is equal to 1, it indicates that each attribute tile of the attribute, indicated for each piece of attribute video data, having the index attrIdx includes one tile partition. In a case that afati_single_partition_per_tile_flag[attrIdx] is equal to 0, it indicates that the attribute tile, for each piece of attribute video data, having the index attrIdx may include multiple attribute tile partitions. In a case of not being present, the value of afati_single_partition_per_tile_flag[attrIdx] is inferred to be equal to 1.

afati_num_tiles_in_atlas_frame_minus1[attrIdx]: value obtained by adding 1 to afati_num_tiles_in_atlas_frame_minus1[attrIdx] indicates the number of attribute tiles in each attribute atlas frame of the attribute signaled in an attribute video data unit having the index attrIdx. The value of afati_num_tiles_in_atlas_frame_minus1[attrIdx] is within a range of 0 to NumPartitionsInAtlasFrameAtt[attrIdx]−1. In a case that afati_num_tiles_in_atlas_frame_minus1[attrIdx] is not present, and afati_single_partition_per_tile_flag[attrIdx] is equal to 1, the value of afati_num_tiles_in_atlas_frame_minus1[attrIdx] is inferred to be equal to NumPartitionsInAtlasFrameAtt[attrIdx]−1. Here, the variable NumPartitionsInAtlasFrameAtt[attrIdx] is set equal to NumPartitionColumnsAtt[attrIdx]*NumPartitionRowsAtt[attrIdx]. In a case that afati_single_tile_in_atlas_frame_flag[attrIdx] is equal to 0, NumPartitionsInAtlasFrameAtt[attrIdx] shall be greater than 1.

afati_top_left_partition_idx[attrIdx][i]: afati_top_left_partition_idx[attrIdx][i] indicates a partition index of the attribute tile partition located at the top left corner of the i-th tile of the attribute video data having the index attrIdx. The value of afati_top_left_partition_idx[attrIdx][i] is within a range of 0 to NumPartitionsInAtlasFrameAtt[attrIdx]−1. The length of the afati_top_left_partition_idx[attrIdx][i] syntax element is Ceil(Log2(NumPartitionsInAtlasFrameAtt[attrIdx])) bits.

afati_bottom_right_partition_column_offset[attrIdx][i]: afati_bottom_right_partition_column_offset[attrIdx][i] indicates an offset between the column position of the attribute tile partition in the attribute video data having the index attrIdx located at the bottom right corner of the i-th attribute tile and the column position of the attribute tile partition having the partition index equal to afati_bottom_right_partition_column_offset[attrIdx][i]. In a case that afati_single_partition_per_tile_flag[attrIdx] is equal to 1, the value of afati_bottom_right_partition_column_offset[attrIdx][i] is inferred to be equal to 0.

afati_bottom_right_partition_row_offset[attrIdx][i]: afati_bottom_right_partition_row_offset[attrIdx][i] indicates an offset between the row position of the attribute tile partition in the attribute video data having the index attridx located at the bottom right corner of the i-th attribute tile and the row position of the attribute tile partition having the partition index equal to afati_top_left_partition_idx[attrIdx][i]. In a case that afati_single_partition_per_tile_flag[attrIdx] is equal to 1, the value of afati_bottom_right_partition_row_offset[attrIdx][i] is inferred to be equal to 0.

afati_signalled_tile_id_flag[attrIdx]: in a case that lafati_signalled_tile_id_flag[attrIdx] is equal to 1, it indicates that the attribute tile ID of each attribute tile in the attribute video data having the index attrIdx is signaled. In a case that afati_signalled_tile_id_flag[attrIdx] is equal to 0, it indicates that the attribute tile ID is not signaled.

afati_signalled_tile_id_length_minus 1[attrIdx]: in a case that a syntax element afati_tile_id[attrIdx][i] is present, the value obtained by adding 1 to afati_signalled_tile_id_length_minus 1[attrIdx] indicates the number of bits used to express the syntax element. The value of afati_signalled_tile_id_length_minus1[attrIdx] is within a range of 0 to 15. In a case of not being present, the value of afati_signalled_tile_id_length_minus1[attrIdx] is inferred to be equal to Ceil(Log2 afati_num_tiles_in_atlas_frame_minus 1[attrIdx]+1))−1.

afati_tile_id[attrIdx][i]: it indicates the attribute tile ID of the i-th attribute tile of the attribute video data having the index attridx. In a case of not being present, the value of afati_tile_id[attrIdx][i] is inferred to be equal to i for each i within a range of 0 to afati_num_tiles_in_atlas_frame_minus 1[attrIdx]. afati_tile_id[attrIdx][i] not being equal to afati_tile_id[attrIdx][j] for all of i!=j is a bitstream conformance requirement. A variable FirstTileIDAtt[attrIdx] is calculated as follows.

```
FirstTileIDAtt[attrIdx] = afati_tile_id[attrIdx][ 0 ]
  for(i = 1; i < afati_num_tiles_in_atlas_frame_minus1[attrIdx] +
  1; i++)
    FirstTileIDAtt[attrIdx] =
      Min( FirstTileID[attrIdx], afati_tile_id[attrIdx][ i ] )
```

Arrays TileIDToIndexAtt[attrIdx] and TileIndex ToIDAtt[attrIdx] provide mapping of IDs associated with respective attribute tiles and order indices regarding how the attribute tiles are indicated in the attribute tile information of the atlas frame in a forward direction and a backward direction, respectively.

### Configuration of Attribute Tile Information Syntax

The attribute frame can be divided into units of one or more partitions, and attribute tiles can include the units (partitions). Typical cases include the following:
The attribute frame is not divided, and the whole attribute frame is used as one attribute tile (afati_single_tile_in_atlas_frame_flag[attrIdx]==1).
The attribute frame is divided into multiple partitions, and one partition is used as one attribute tile (afati_single_tile_in_atlas_frame_flag[attrIdx]==0 and afati_single_partition_per_tile_flag[attrIdx]==1).
The attribute frame is divided into multiple partitions, and one or more horizontally and vertically consecutive partitions are used as one attribute tile (afati_single_tile_in_atlas_frame_flag[attrIdx]==0 and afati_single_partition_per_tile_flag[attrIdx]==0).

Note that the attribute frame can be divided into tile partitions (hereinafter also referred to as partitions) of NumPartitionColumns*NumPartitionRows, and in a case of division, a case of division of the frame at equal intervals or a case of division in indicated units can be selected. NumPartitionColumns and NumPartitionRows represent the number of partition divisions in the horizontal direction and the vertical direction, respectively.

Note that the tile is not limited to the attribute frame, and may be an attribute, a geometry, a displacement, or a mesh. In other words, the following syntax elements and the bitstream conformance condition thereof can also be used for attribute, geometry, displacement, and mesh tiles.

FIG. 11 is a diagram of syntax indicating atlas_frame_attribute_tile_information() tile information for V-DMC.

The extension information decoder 3023 of the atlas information decoder 302 decodes the syntax element afati_single_tile_in_atlas_frame_flag[attrIdx].

afati_single_tile_in_atlas_frame_flag[attrIdx] is a binary flag indicating whether or not the attribute frame includes a single tile, and has a value (for example, 1) indicating that the attribute frame includes a single tile or a value (for example, 0) indicating that the attribute frame includes multiple tiles. In a case that the value of afati_single_tile_in_atlas_frame_flag[attrIdx] is a value indicating multiple tiles, the extension information decoder 3023 decodes the syntax element afati_uniform_partition_spacing_flag[attrIdx]. Here, afati_uniform_partition_spacing_flag[attrIdx] is a binary flag indicating whether or not the attribute frame is divided into partitions at equal intervals, and has a value (for example, 1) indicating that the attribute frame is divided into partitions at equal intervals or a value (for example, 0) indicating that the attribute frame is not divided into partitions at equal intervals.

The extension information decoder 3023 derives a parameter indicating the position and the size of the tile.
Case that afati_uniform_partition_spacing_flagAtt[attrIdx] is a value indicating 1

The extension information decoder 3023 decodes syntax elements afati_partition_cols_width_minus 1[attrldx] and afati_partition_cols_width_minus 1[attrIdx] indicating the width (column width) and the height (row height) of each partition except the rightmost column (right edge column) and the bottommost row (bottom edge row). In each of i=0. NumPartitionColumnsAtt[attrIdx]−1 and j=0. NumPartitionRowsAtt[attrIdx], PartitionPosXAtt[attrIdx][i], PartitionPos Y Att[attrIdx][j], Partition WidthAtt[attrIdx][i], and PartitionHeightAtt[attrldx][j] indicating the x and y coordinates, the width, and the height of the top left of each partition are derived as follows.

```
  widthPartition = ( afati_partition_cols_width_minus1[attrIdx] + 1 ) * 64
  NumPartitionColumnsAtt[attIdx] = asve_attribute_frame_width[attrIdx] / widt
hPartition
  PartitionPosXAtt[attrIdx][ 0 ] = 0
  PartitionWidthAtt[attrIdx][ 0 ] = widthPartition
  for( i = 1: i < NumPartitionColumnsAtt[attrIdx] − 1; i++ ) {
    PartitionPosXAtt[attrIdx][ i ] = PartitionPosXAtt[attrIdx][ i − 1 ] + Par
titionWidthAtt[attrIdx][ i − 1 ]
    PartitionWidthAtt[attrIdx][ i ] = widthPartition
  }
  partitionHeightAtt[attrIdx] = (afati_partition_rows_height_minus1[attrIdx]
+ 1) * 64
  NumPartitionRowsAtt[attrIdx] = asve_attribute_frame_height[attrIdx] / parti
tionHeight
  PartitionPosYAtt[attrIdx][ 0 ] = 0
  PartitionHeightAtt[attrIdx][ 0 ] = heightPartition
  for( j = 1; j < NumPartitionRowsAtt[attrIdx] − 1; j++ ) {
    PartitionPosYAtt[attrIdx][ j ] = PartitionPosYAtt[attrIdx] [ j − 1 ] + Pa
rtitionHeightAtt[attrIdx][ j − 1 ]
    PartitionHeightAtt[attrIdx][ j ] = heightPartition
  }
```

Case that afati_uniform_partition_spacing_flagAtt[attrIdx] is a value indicating 0

The extension information decoder 3023 decodes the syntax elements afati_num_partition_columns_minus 1[attrIdx] and afati_num_partition_rows_minus1[attrIdx] indicating the number of atlas tile partitions in the horizontal direction and the height direction.

In each of i=0. NumPartitionColumnsAtt[attrIdx]−1 and j=0. NumPartitionRowsAtt[attrIdx], PartitionPosXAtt[attrIdx][i], PartitionPos Y Att[attrIdx][j], Partition WidthAtt[attrIdx][i], and PartitionHeightAtt[attrIdx][j] indicating the x and y coordinates, the width, and the height of the top left of each partition are derived as follows.

```
  NumPartitionColumnsAtt[attrIdx] = afati_num_partition_columns_minus1[attrId
x] + 1
  PartitionPosXAtt[attrIdx][ 0 ] = 0
  partitionWidthAtt[attrIdx][ 0 ] = ( afati_partition_column_width_minus1[att
rIdx][ 0 ] + 1 ) * 64
  for( i = 1; i < NumPartitionColumnsAtt[attrIdx] − 1; i++ ) {
    PartitionPosXAtt[attrIdx][ i ] = PartitionPosXAtt[attrIdx][ i − 1 ] + Par
titionWidthAtt[attrIdx][ i − 1 ]
    PartitionWidthAtt[attrIdx][ i ] = ( afati_partition_column_width_minus1[a
ttrIdx][ i ] + 1 ) * 64
  }
  NumPartitionRowsAtt[attrIdx] = afati_num_partition_rows_minus1[attrIdx] + 1
  PartitionPosYAtt[attrIdx][ 0 ] = 0
  PartitionHeightAtt[attrIdx][ 0 ] = ( afati_partition_row_height_minus1[attr
Idx][ 0 ] + 1 ) * 64
  for( j = 1; j < NumPartitionRowsAtt[attrIdx] − 1; j++ ) {
    PartitionPosYAtt[attrIdx][ j ] = PartitionPosYAtt[attrIdx][ j − 1 ] + Par
titionHeightAtt[attrIdx][ j − 1 ]
    PartitionHeightAtt[attrIdx][ j ] = ( afati_partition_row_height_minus1[at
trIdx][ j ] + 1 ) * 64
  }
```

In a case that the number of partitions in the horizontal direction and the height direction is equal to or greater than 2, PartitionPosXAtt[attrIdx][i], PartitionPos Y Att[attrIdx][j], Partition WidthAtt[attrIdx][i], and PartitionHeightAtt[attrIdx][j] indicating the x and y coordinates, the width, and the height of the top left of each partition on the rightmost and the bottommost are derived as follows.

$$PartitionPosXAtt [ attrIdx ] [ NumPartitionColumnsAtt [ attrIdx - 1 ] = PartitionPosXAtt [ attrIdx ] [ NumPartitionColumnsAtt [ attrIdx - 2 ] + PartitionWidthAtt [ attrIdx ] [ NumPartitionColumnsAtt [ attrIdx ] - 2 ]$$

$$PartitionWidthAtt [ attrIdx ] [ NumPartitionColumnsAtt [ attrIdx ] - 1 ] = asve\_attribute \_frame \_width [ attrIdx ] - PartitionPosXAtt [ attrIdx ] [ NumPartitionColumnsAtt [ attrIdx ] - 1 ]$$

$$PartitionPosYAtt [ attrIdx ] [ NumPartitionRowsAtt [ attrIdx - 1 ] = PartitionPosYAtt [ attrIdx ] [ NumPartitionRowsAtt [ attrIdx - 2 ] + partitionHeightAtt [ attrIdx ] [ NumPartitionRowsAtt [ attrIdx ] - 2 ]$$

$$PartitionHeight [ NumPartitionRowsAtt [ attrIdx ] - 1 ] = asve\_attribute \_frame \_height [ attrIdx ] - PartitionPosYAtt [ attrIdx ] [ NumPartitionRows - 1 ]$$

Here, the width and the height of each partition are set equal to a multiple of 64, but is not limited to 64, and 64 may be replaced by 32, 128, or 256.

The extension information decoder 3023 decodes the syntax element afati_single_partition_per_tile_flag[attrIdx]. Here, afati_single_partition_per_tile_flag[attrIdx] is a flag indicating whether or not each tile includes only a single partition, and has a value (for example, 1) indicating that each tile includes only a single partition or a value (for example, 0) indicating that each tile includes multiple partitions. In a case that afati_single_partition_per_tile_flag[attrIdx] is a value indicating multiple partitions, the extension information decoder 3023 decodes the syntax element afati_num_tiles_in_atlas_frame_minus1[attrIdx], and performs the following processing of deriving parameters of tiles from one or more selected partitions. Here, afati_num_tiles_in_atlas_frame_minus1 is the number of tiles included in the attribute frame.

The extension information decoder 3023 decodes syntax elements afati_top_left_partition_idxAtt[attrIdx][i], afati_bottom_right_partition_column_offset[attrIdx][i], and afati_bottom_right_partition_row_offset[attrIdx][i] with respect to each of i=0. afati_num_tiles_in_atlas_frame_minus 1[attrIdx]. Here, afati_top_left_partition_idx[attrIdx][i] is an index of a partition in which the top left edge (corner, point) of the i-th tile is located, afati_bottom_right_partition_column_offset[attrIdx][i] is the amount of offset in the horizontal direction of the bottom right edge of the i-th tile with respect to the top left edge of the i-th tile, and afati_bottom_right_partition_row_offset[attrIdx][i] is the amount of offset in the height direction of the bottom right edge of the i-th tile with respect to the top left edge of the i-th tile.

Based on the decoded syntax, indices topLeftColumnAtt[attrIdx][i], topLeftRowAtt[attrIdx][i], bottomRightColumnAtt[attrIdx][i], and bottomRightRowAtt[attrIdx][i] of the partitions on the top left in the horizontal direction and the height direction and on the bottom right in the horizontal direction and the height direction of each tile i are derived as follows.

$$topLeftColumnAtt [ attrIdx ] [ i ] = afati\_top \text{} \_left \text{} \_partition \text{} \_idxAtt [ attrIdx ] [ i ] \% NumPartitionColumnsAtt [ attrIdx ]$$

$$topLeftRowAtt [ attrIdx ] [ i ] = afati\_top \_left \_partition \_idxAtt [ attrIdx ] [ i ] / NumPartitionColumnsAtt [ attrIdx ]$$

$$bottomRightColumnAtt [ attrIdx ] [ i ] = topLeftColumnAtt [ attrIdx ] [ i ] + afati\_bottom \_right \_partition \_column \_offsetAtt [ attrIdx ] [ i ]$$

$$bottomRightRowAtt [ attrIdx ] [ i ] = topLefRowAtt [ attrIdx ] [ i ] + afati\_bottom \_right \_partition \_row \_offsetAtt [ attrIdx ] [ i ]$$

Here, bottomRightColumnAtt[attrIdx][i] and bottomRightRowAtt[attrIdx][i] may be (asve_attribute_frame_width[attrIdx]+63)/64−1 and (asve_attribute_frame_height[attrIdx]+63)/64−1 or less, respectively.

The 3D data decoding apparatus 31 that decodes mesh data or point cloud data may include a component that decodes a syntax element indicating a position of an attribute tile, and derives a column topLeftColumnAtt[attrIdx] in the top left partition and a row topLeftRowAtt[attrIdx] in the top left partition of the tile and a column bottomRightColumnAtt[attrIdx] in the bottom right partition and a row bottomRightRowAtt[attrIdx] in the bottom right partition of the attribute tile, and the 3D data decoding apparatus 31 may decode a bitstream satisfying a specific bitstream conformance condition regarding the partition columns (topLeftColumnAtt[attrIdx][i] and bottomRightColumnAtt[attrIdx][i]) of the i-th attribute tile, the partition column (topLeftColumnAtt[attrIdx][j]) of the j-th attribute tile, the partition rows (topLeftRowAtt[attrIdx][i] and bottomRightRowAtt[attrIdx][i]) of the i-th attribute tile, and the partition row (topLeftRowAtt[attrIdx][j]) of the j-th attribute tile. The 3D data decoding apparatus 31 may decode the bitstream satisfying the following bitstream conformance condition.

### Bitstream Restriction 1

As the bitstream conformance, a case satisfying, for i and j (j!=i), both of the following properties shall not be included:

$$topLeftColumnAtt [ attrIdx ] [ i ] <= topLeftColumnAtt [ attrIdx ] [ j ] <= bottomRightColumnAtt [ attrIdx ] [ i ] ; and$$

$$topLeftRowAtt [ attrIdx ] [ i ] <= topLeftRowAtt [ attrIdx ] [ j ] <= bottomRightRowAtt [ attrIdx ] [ i ] .$$

In the restriction, there is an effect that overlapping of different attribute tiles is forestalled. The decoding apparatus does not decode a bitstream in which different attribute tiles overlap, and therefore complexity is reduced.

The encoding apparatus generates a bitstream by configuring attribute tiles to satisfy neither of the conditions with respect to different attribute tiles i and j.

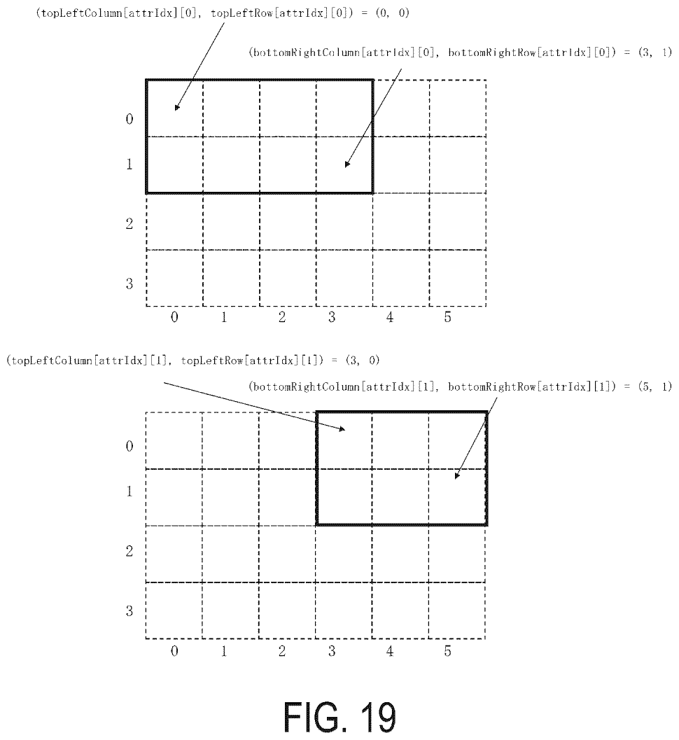

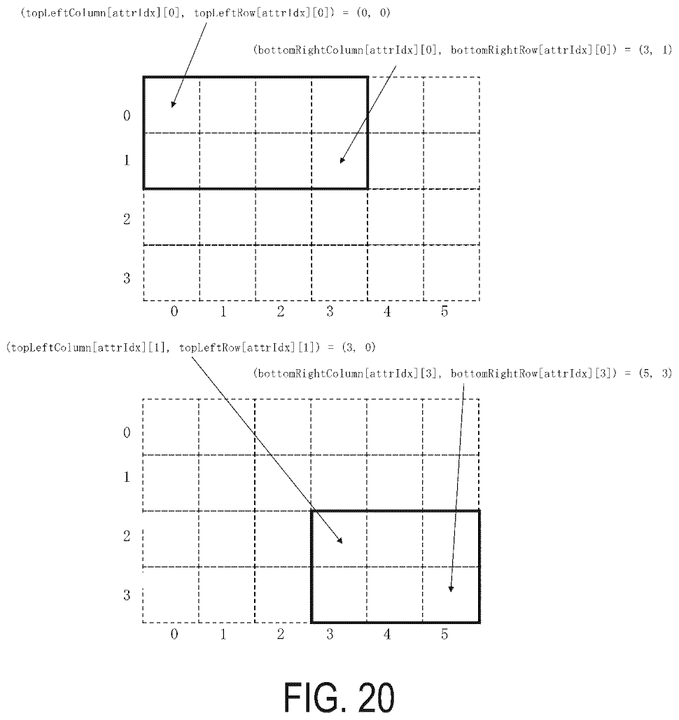

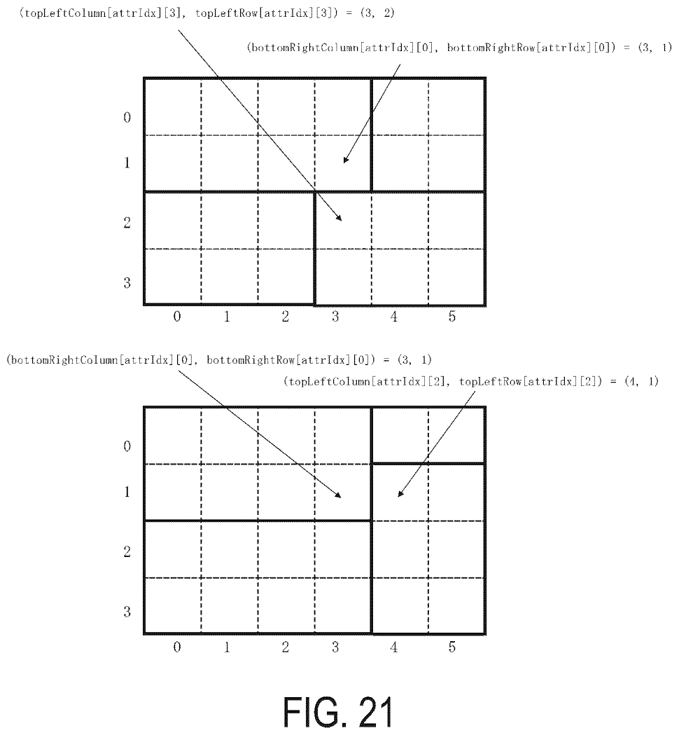

FIG. 19, FIG. 20, and FIG. 21 are examples of divisions of attribute tiles. A square dotted line indicates a partition.

In the example of FIG. 19, there is overlapping between the attribute tile of i=0 and the attribute tile of j=0. Because both of the properties are satisfied in i=0 and j=1, this disagrees with the bitstream condition. Conversely, as long as the bitstream condition is abided, overlapping of attribute tiles can be forestalled.

In the example of FIG. 20, there is not overlapping between the attribute tile of i=0 and the attribute tile of j=0. Because only one of the properties is satisfied in i=0 and j=1, this agrees with the bitstream condition. The example of FIG. 21 also similarly agrees with the bitstream condition and can be thus implemented.

### Bitstream Restriction 2

As another configuration, as the bitstream conformance, a case satisfying, for i and j (j!=i), one of the following properties shall not be included:

$$topLeftColumnAtt [ attrIdx ] [ i ] <= topLeftColumnAtt [ attrIdx ] [ j ] <= bottomRightColumnAtt [ attrIdx ] [ i ] ; and$$

$$topLeftRowAtt [ attrIdx ] [ i ] <= topLeftRowAtt [ attrIdx ] [ j ] <= bottomRightRowAtt [ attrIdx ] [ i ] .$$

In the configuration, in a case of division of the attribute tiles of FIG. 20, topLeftColumnAtt[attrIdx][i]<=topLeftColumnAtt[attrIdx][j]<=bottomRightColumnAtt[attrIdx][i] is satisfied, and topLeftRowAtt[attrIdx][i]<=topLeftRowAtt[attrIdx][j]<=bottomRightRowAtt[attrIdx][i] is not satisfied. Because one of them is satisfied, this disagrees with the bitstream condition. In other words, an example in which the positions of boundaries of the attribute tiles being alternated in the frame is prohibited. In the example, the example of FIG. 21 also similarly disagrees with the bitstream condition. Note that, in the example, restriction on the case satisfying both of the properties as in FIG. 19 is ambiguous.

### Bitstream Restriction 3

As another configuration, as the bitstream conformance, a case satisfying, for i and j (j!=i), one or both of the following properties shall not be included:

$$topLeftColumnAtt [ attrIdx ] [ i ] <= topLeftColumnAtt [ attrIdx ] [ j ] <= bottomRightColumnAtt [ attrIdx ] [ i ] ; and$$

$$topLeftRowAtt [ attrIdx ] [ i ] <= topLeftRowAtt [ attrIdx ] [ j ] <= bottomRightRowAtt [ attrIdx ] [ i ] .$$

The following expression representing a similar restriction may be used. As the bitstream conformance, a case satisfying, for i and j (j!=i), one or more of the following properties shall not be included:

$$topLeftColumnAtt [ attrIdx ] [ i ] <= topLeftColumnAtt [ attrIdx ] [ j ] <= bottomRightColumnAtt [ attrIdx ] [ i ] ; and$$

$$topLeftRowAtt [ attrIdx ] [ i ] <= topLeftRowAtt [ attrIdx ] [ j ] <= bottomRightRowAtt [ attrIdx ] [ i ] .$$

In the configuration, this disagrees with the cases of division of the attribute tiles of FIG. 19, FIG. 20, and FIG. 21.

The restriction may also be used as the bitstream configuration in a case that the codec is HEVC.

### Bitstream Restriction 4

As another configuration, as the bitstream conformance, a case satisfying, for i and j (j!=i), the following property shall not be included:

$$topLeftColumnAtt [ attrIdx ] [ i ] <= topLeftColumnAtt [ attrIdx ] [ j ] <= bottomRightColumnAtt [ attrIdx ] [ i ] .$$

In the configuration, this disagrees with the bitstream condition in division of the attribute tiles in FIG. 19, FIG. 20, and the upper half of FIG. 21, but does not disagree therewith in division of the attribute tiles in the lower half of FIG. 21. The example does not allow slice divisions, which are allowed in VVC slice divisions, to be alternated in the horizontal direction, but allows slice divisions to be alternated in the vertical direction. The restriction may also be used as the bitstream configuration in a case that the codec is VVC.

### Configuration for Each Codec

Depending on a type of video codec to be used in encoding of attributes, the bitstream condition for attribute tiles may be changed. For example, for AVC and HEVC, bitstream restriction 3 may be used, and for VVC, bitstream restriction 4 may be used. As described above, the type of the codec may be determined using one of ptl_profile_codec_group_idc obtained by decoding the V3C parameter set of encoded data, gi_attribute_codec_id[atlasID] of the V3C parameter set, bmsps_intra_mesh_codec_id of the base mesh, bmsps_inter_mesh_codec_id, and dsps_codec_id of the displacement.

In other words, the 3D data decoding apparatus further decodes a syntax element indicating the codec, and in a case that the codec is AVC or HEVC, the bitstream conformance is as follows:

$$topLeftColumnAtt [ attrIdx ] [ i ] <= topLeftColumnAtt [ attrIdx ] [ j ] <= bottomRightColumnAtt [ attrIdx ] [ i ]$$

$$topLeftRowAtt [ attrIdx ] [ i ] <= topLeftRowAtt [ attrIdx ] [ j ] <= bottomRightRowAtt [ attrIdx ] [ i ]$$

The bitstream conformance with the codec being VVC is topLeftColumnAtt[attrIdx][i]<=topLeftColumnAtt[attrIdx][j]<=bottomRightColumnAtt[attrIdx][i].

Example of Case that Multiple Pieces of Attribute Tile Information May Have Same Attribute Tile Division Information

The extension information decoder 3023 being a constituent element of the atlas information decoder 302 decodes the tile information of the attribute as additional information (afps_vdmc_extension) for V-DMC. More specifically, attribute tile information atlas_frame_attribute_tile_information is decoded for each index attrIdx of the attribute in each attribute as one piece of information included in afps_vdmc_extension. However, in a case that the atlas tile information and the attribute tile information are consistent (that is, tile division of atlas_frame_tile_information and tile division of atlas_frame_attribute_tile_information are equal), there is a problem in that transmission of the attribute tile information is redundant, which makes encoding inefficient. In view of this, as in the example of the syntax illustrated in FIG. 9, a flag afve_consistent_tiling_across_atlas_and_attribute_flag indicating whether or not the atlas tile information and the attribute tile information are consistent is used, and in a case that the atlas tile information and the attribute tile information are consistent (the flag is TRUE), the attribute tile information atlas_frame_attribute_tile_information is not decoded. Instead, as illustrated in the semantics to be described later, in a case that the attribute tile information is not present in encoded data, syntax information of the attribute tile information is derived using a syntax element (a first element, a first syntax element) of the atlas tile information. Otherwise (the flag is FALSE), the attribute tile information for each attrIdx is decoded with the loop of the index attrIdx.

```
afps_vdmc_extension( ){
  ...
  afve_consistent_tiling_across_atlas_and_attribute_flag
  if( !afve_consistent_tiling_across_atlas_and_attribute_flag ){
    for( attrIdx=0; attrIdx < asve_num_attribute_video; attrIdx++ )
      atlas_frame_attribute_tile_information( attrIdx )
  }
...
}
```

Semantics may be as follows.

afve_consistent_tiling_across_atlas_and_attribute_flag: in a case that afve_consistent_tiling_across_atlas_and_attribute_flag is 1, atlas_frame_attribute_tile_information is not encoded or decoded, and transmitted atlas_frame_tile_information is decoded as atlas_frame_attribute_tile_information. In a case that afve_consistent_tiling_across_atlas_and_attribute_flag is 0, the attribute tile information for each attrIdx is decoded with the loop of the index attrIdx.

According to the configuration, there is an effect that the amount of codes is reduced by encoding and decoding only differences between the atlas tile information and the attribute tile information.

### Other Configuration Example 1

The extension information decoder 3023 decodes the attribute tile information atlas_frame_attribute_tile_information for each attrIdx as described above as additional information (afps_vdmc_extension) for V-DMC. However, in a case that the attribute tile information are consistent (that is, the same between all attributes), there is a problem in that overlapping transmission of the same attribute tile information for the attributes is redundant, which makes encoding inefficient. In view of this, as described below, a flag afve_consistent_tiling_across_attribute_video_flag indicating whether or not the attribute tile information is consistent between all attributes is used, and in a case that the attribute tile information is consistent (the flag is TRUE), only the first of attribute tile information is transmitted for the attributes (it is present in encoded data only for attrIdx==0 and is not transmitted for attrIdx!=0), otherwise (the flag is FALSE), the attribute tile information for each attrIdx is decoded with the loop of the index attrIdx.

```
afps_vdmc_extension( ){
  ...
  afve_consistent_tiling_across_attribute_video_flag
  if( afve_consistent_tiling_across_attribute_video_flag )
    atlas_frame_attribute_tile_information( 0 )
  else{
    for( attrIdx=0; attrIdx < asve_num_attribute_video; attrIdx++ )
      atlas_frame_attribute_tile_information( attrIdx )
  }
...
}
```

Semantics may be as follows.

afve_consistent_tiling_across_attribute_video_flag: in a case that afve_consistent_tiling_across_attribute_video_flag is 1, atlas_frame_attribute_tile_information is indicated only for a first (index attrIdx==0) attribute, and other attribute tile information (attrIdx!=0) are duplicated from the first attribute. In a case that afve_consistent_tiling_across_attribute_video_flag is 0, atlas_frame_attribute_tile_information is indicated for each attribute.

According to the configuration, there is an effect that the amount of codes is reduced by encoding and decoding only different attribute tile information.

### Other Configuration Example 2

In another configuration, as described below, the flag afve_consistent_tiling_across_attribute_video_flag indicating whether or not the attribute tile information is consistent and the flag afve_consistent_tiling_across_atlas_and_attribute_flag indicating whether or not the atlas tile information and the attribute tile information are consistent are used, and in a case that the atlas tile information and the attribute tile information are consistent (afve_consistent_tiling_across_atlas_and_attribute_flag is TRUE), the attribute tile information is not decoded. In a case of not being decoded or being present, derivation is performed using the semantics described above. Conversely, in a case that afve_consistent_tiling_across_atlas_and_attribute_flag is FALSE, afve_consistent_tiling_across_attribute_video_flag is further decoded. In a case that the attribute tile information is consistent (afve_consistent_tiling_across_attribute_video_flag is TRUE), only the first of attribute tile information is transmitted for the attributes (it is present in encoded data only for attrIdx==0 and is not transmitted for attrIdx!=0), and in a case that the attribute tile information may be inconsistent (afve_consistent_tiling_across_attribute_video_flag is FALSE), the attribute tile information for each attrIdx may be decoded with the loop of the index attrIdx.

```
afps_vdmc_extension( ){
  ...
  afve_consistent_tiling_across_atlas_and_attribute_flag
  if( !afve_consistent_tiling_across_atlas_and_attribute_flag ){
    afve_consistent_tiling_across_attribute_video_flag
    if( afve_consistent_tiling_across_attribute_video_flag ){
      atlas_frame_attribute_tile_information( 0 )
    }else{
      for( attrIdx=0; attrIdx < asve_num_attribute_video; attrIdx++ )
        atlas_frame_attribute_tile_information( attrIdx )
    }
  }
...
}
```

Alternatively, as described below, the flag afve_consistent_tiling_across_attribute_video_flag may be positioned higher than the flag afve_consistent_tiling_across_atlas_and_attribute_flag. In this case, in a case that afve_consistent_tiling_across_attribute_video_flag is true, afve_consistent_tiling_across_atlas_and_attribute_flag is further decoded.

```
afps_vdmc_extension( ){
  ...
  afve_consistent_tiling_across_attribute_video_flag
  if( afve_consistent_tiling_across_attribute_video_flag ){
    afve_consistent_tiling_across_atlas_and_attribute_flag
      if( !afve_consistent_tiling_across_atlas_and_attribute_flag )
        atlas_frame_attribute_file_information( 0 )
  }else{
    for( attrIdx=0; attrIdx < asve_num_attribute_video; attrIdx++ )
      atlas_frame_attribute_tile_information( attrIdx )
  }
...
}
```

### Other Configuration Example 3

The extension information decoder 3023 decodes the attribute tile information (atlas_frame_attribute_tile_information) as additional information (afps_vdmc_extension) for V-DMC. More specifically, syntax and the like indicating partition information of the attribute tile are decoded for each index attrIdx. However, in a case that a part or all of the atlas tile information and the attribute tile information are consistent (that is, information transmitted with atlas_frame_tile_information and information transmitted with atlas_frame_attribute_tile_information are partially or entirely the same), there is a problem in that transmission of the attribute tile information overlapping the atlas tile information is redundant, which makes encoding inefficient. In view of this, as in the example of the syntax illustrated in FIG. 11, a flag afati_consistent_tiling_across_atlas_and_attribute_flag[attrIdx] indicating whether or not a part or all of the attribute tile information identified with the index attrIdx is equal to the atlas tile information is used, and in a case that the attribute tile information of the attribute indicated by the index attrIdx is equal to the atlas tile information (the flag is TRUE), the atlas tile information of attrIdx is regarded as the attribute tile information (the attribute tile information of attrIdx is not present in encoded data, only the atlas tile information is transmitted, and the transmitted atlas tile information is decoded as the attribute tile information of attrIdx), otherwise (the flag is FALSE), the attribute tile information for the index attrIdx is decoded. The configuration of decoding the atlas tile information as a part or all of the attribute tile information eliminates redundancy (the same applies hereinafter).

```
atlas_frame_attribute_tile_information( attrIdx ){
  afati_single_tile_in_atlas_frame_flag[attrIdx]
  afati_consistent_tiling_across_atlas_and_attribute_flag[attrIdx]
  if( !afati_single_tile_in_atlas_frame_flag[attrIdx] &&
    !afati_consistent_tiling_across_atlas_and_attribute_flag[attrIdx]
    ){
    afati_uniform_partition_spacing_flag[attrIdx]
    ...
}
```

Semantics may be as follows.

afati_consistent_tiling_across_atlas_and_attribute_flag[attrIdx]: in a case that afati_consistent_tiling_across_atlas_and_attribute_flag[attrIdx] is 1, the attribute tile information of the index attrIdx duplicates atlas_frame_tile_information for use. In a case that afati_consistent_tiling_across_atlas_and_attribute_flag[attrIdx] is 0, the attribute tile information of the index attrIdx is indicated.

### Variable Derivation Configuration Example 1

In a case that the flag afve_consistent_tiling_across_attribute_video_flag is equal to 1, or the flag afati_consistent_tiling_across_atlas_and_attribute_flag[attrIdx] is equal to 1, only the width and the height of the first attribute tile partition are indicated by the attribute tile information syntax of the atlas frame. The attribute frame of the attribute having the index attrIdx =0 is divided into NumPartitionColumnsAtt[0]*NumPartitionRowsAtt[0] attribute tile partitions. Here, NumPartitionColumnsAtt[0] and NumPartitionRowsAtt[0] are derived as follows with index attrIdx=0.

```
if( afve_consistent_tiling_across_attribute_video_flag ||
  !afati_consistent_tiling_across_atlas_and_attribute_flag[attrIdx] ) {
  NumPartitionColumnsAtt[attrIdx] =
    afati_num_partition_columns_minus1[attrIdx] + 1
  PartitionPosXAtt[attrIdx][ 0 ] = 0
  partitionWidthAtt[attrIdx][ 0 ] =
    ( afati_partition_column_width_minus1[attrIdx][ 0 ] + 1 ) * 64
  for( i = 1: 1 < NumPartitionColumnsAtt[attrIdx] − 1; i++ ) {
    PartitionPosXAtt[attrIdx][ i ] = PartitionPosXAtt[attrIdx][ i − 1 ] +
      PartitionWidthAtt[attrIdx][ i − 1 ]
    PartitionWidthAtt[attrIdx][ i ] =
      ( afati_partition_column_width_minus1[attrIdx][ i ] + 1 ) * 64
  }
  NumPartitionRowsAtt[attrIdx] = afati_num_partition_rows_minus1[attrIdx] + 1
  PartitionPosYAtt[attrIdx][ 0 ] = 0
  PartitionHeightAtt[attrIdx][ 0 ] =
    ( afati_partition_row_height_minus1[attrIdx][ 0 ] + 1 ) * 64
  for( j = 1; j < NumPartitionRowsAtt[attrIdx] − 1; j++ ) {
    PartitionPosYAtt[attrIdx][ j ] = PartitionPosYAtt[attrIdx][ j − 1 ] +
      PartitionHeightAtt[attrIdx][ j − 1 ]
    PartitionHeightAtt[attrIdx][ j ] =
      ( afati_partition_row_height_minus1[attrIdx][ j ] + 1 ) * 64
  }
}
```

Instead of the derivation method, NumPartitionColumnsAtt[0] and NumPartitionRowsAtt[0] may be derived using the following method.

```
if( afve_consistent_tiling_across_attribute_video_flag ||
  !afati_consistent_tiling_across_atlas_and_attribute_flag[attrIdx] ) {
  NumPartitionColumnsAtt[attrIdx] =
    afati_num_partition_columns_minus1[attrIdx] + 1
  PartitionPosXAtt[attrIdx][ 0 ] = 0
  partitionWidthAtt[attrIdx][ 0 ] =
    ( afati_partition_column_width_minus1[attrIdx][ 0 ] + 1 ) * 64
  for( i = 1; i < NumPartitionColumnsAtt[attrIdx]; i++ ) {
    PartitionPosXAtt[attrIdx][ i ] = PartitionPosXAtt[attrIdx][ i − 1 ] +
      PartitionWidthAtt[attrIdx][ i − 1 ]
    PartitionWidthAtt[attrIdx][ i ] =
      ( afati_partition_column_width_minus1[attrIdx][ i ] + 1 ) * 64
  }
  NumPartitionRowsAtt[attrIdx] = afati_num_partition_rows_minus1[attrIdx] + 1
  PartitionPosYAtt[attrIdx][ 0 ] = 0
  PartitionHeightAtt[attrIdx][ 0 ] =
    ( afati_partition_row_height_minus1[attrIdx][ 0 ] + 1 ) * 64
  for( j = 1; j < NumPartitionRowsAtt[attrIdx]; j++ ) {
    PartitionPosYAtt[attrIdx][ j ] = PartitionPosYAtt[attrIdx][ j − 1 ] +
      PartitionHeightAtt[attrIdx][ j − 1 ]
    PartitionHeightAtt[attrIdx][ j ] =
      ( afati_partition_row_height_minus1[attrIdx][ j ] + 1 ) * 64
  }
}
```

In a case that the flag afve_consistent_tiling_across_attribute_video_flag is equal to 1, or the flag afati_consistent_tiling_across_atlas_and_attribute_flag[attrIdx] is equal to 1, the attribute tile partition is initialized from a value decoded for the attribute having index attrIdx=0 for the attribute having the index attrIdx greater than 0. In other words, a variable indicating the position, the width, and the height of the attribute tile partition of attrIdx>0 is derived from a variable indicating the position, the width, and the height of the attribute tile partition of attrIdx==0.

```
if( afve_consistent_tiling_across_attribute_video_flag ||
  !afati_consistent_tiling_across_atlas_and_attribute_flag[attrIdx] ) {
  widthRatio =
    asve_attribute_frame_width[attrIdx] ÷ asve_attribute_frame_width[ 0 ]
  NumPartitionColumnsAtt[attrIdx] = NumPartitionColumnsAtt[ 0 ]
  PartitionPosXAtt[attrIdx][ 0 ] = 0
  partitionWidthAtt[attrIdx][ 0 ] =
    Round(partitionWidthAtt[ 0 ][ 0 ] * widthRatio)
  for( i = 1; i < NumPartitionColumnsAtt[ 0 ]; i++ ) {
    PartitionPosXAtt[attrIdx][ i ] = PartitionPosXAtt[attrIdx][ i − 1 ] +
      PartitionWidthAtt[attrIdx][ i − 1 ]
    PartitionWidthAtt[attrIdx][ i ] =
      Round(partitionWidthAtt[ 0 ][ i ] * widthRatio)
  }
  heightRatio =
    asve_attribute_frame_height[attrIdx] ÷ asve_attribute_frame_height[ 0 ]
  NumPartitionRowsAtt[attrIdx] = NumPartitionRowsAtt[ 0 ]
  PartitionPosYAtt[attrIdx][ 0 ] = 0
  PartitionHeightAtt[attrIdx][ 0 ] =
    Round(PartitionHeightAtt[ 0 ][ 0 ] * heightRatio)
  for( j = 1; j < NumPartitionRowsAtt[ 0 ]; j++ ) {
    PartitionPosYAtt[attrIdx][ j ] = PartitionPosYAtt[attrIdx][ j − 1 ] +
      PartitionHeightAtt[attrIdx][ j − 1 ]
    PartitionHeightAtt[attrIdx][ j ] =
      Round(PartitionHeightAtt[ 0 ][ j ] * heightRatio)
  }
}
```

Here, for widthRatio and heightRatio, a ratio of the width and the height between the tile of attrIdx=0 and the tile of the target attrIdx is used. The width of the tile of attrIdx is derived by multiplying the width of the tile of attrIdx=0 by widthRatio, and the height of the tile of attrIdx is derived by multiplying the height of the tile of attrIdx=0 by heightRatio. This absorbs a difference of resolutions of frames for each attribute, and also supports a case with similar tile divisions (the same applies hereinafter). Here, to calculate the ratio, ÷, which is not integer division but real number division (decimal point division), is used, and widthRatio and heightRatio include a decimal point. This also supports a case that widthRatio and heightRatio include a value of 0.5 being a value other than 1, 2, and 4, that is, resolution of the attribute frame of attrIdx>0 is lower than resolution of the attribute frame of attrIdx==0. For intermediate calculation, decimal point calculation is performed, but by using a Round function, a width, Partition WidthAtt[attrIdx][i], and a height, PartitionHeightAtt[0][j], are converted into integers to be derived. Other than the Round function, Ceil and Floor may be used.

### Variable Derivation Configuration Example 2

Alternatively, in a case that the flag afve_consistent_tiling_across_attribute_video_flag is equal to 1, or the flag afati_consistent_tiling_across_atlas_and_attribute_flag[attrIdx] is equal to 1, the extension information decoder 3023 may perform the following attribute tile partition inference processing. In the processing, for the attribute having the index attrIdx greater than 0, the attribute tile partition may be derived from a width size ratio widthRatio and a height size ratio heightRatio obtained by performing integer division of Acc bits from a value decoded for the attribute of index attrIdx=0 as follows. Here, Acc may be 3 bits or 4 bits, may be 14 bits, or may be other values.

```
if( afve_consistent_tiling_across_attribute_video_flag ||
  !afati_consistent_tiling_across_atlas_and_attribute_flag[attrIdx] ) {
  widthRatio = (asve_attribute_frame_width[attrIdx] << Acc) +
    (asve_attribute_frame_width[ 0 ]>>1) / asve_attribute_frame_width[ 0 ]
  NumPartitionColumnsAtt[attrIdx] = NumPartitionColumnsAtt[ 0 ]
  PartitionPosXAtt[attrIdx][ 0 ] = 0
  partitionWidthAtt[attrIdx][ 0 ] =
    (partitionWidthAtt[ 0 ][ 0 ] * widthRatio + (1<<(Acc−1))) >> Acc
  for( i = 1; i < NumPartitionColumnsAtt[ 0 ]; i++ ) {
    PartitionPosXAtt[attrIdx][ i ] = PartitionPosXAtt[attrIdx][ i − 1 ] +
      PartitionWidthAtt[attrIdx][ i − 1 ]
    PartitionWidthAtt[attrIdx][ i ] =
      (partitionWidthAtt[ 0 ][ i ] * widthRatio + (1<<(Acc−1))) >> Acc
  }
  heightRatio = (asve_attribute_frame_height[attrIdx]<<Acc) +
    (asve_attribute_frame_height[ 0 ]>>1) / asve_attribute_frame_height[ 0 ]
  NumPartitionRowsAtt[attrIdx] = NumPartitionRowsAtt[ 0 ]
  PartitionPosYAtt[attrIdx][ 0 ] = 0
  partitionHeightAtt[attrIdx][ 0 ] =
    (partitionHeightAtt[ 0 ][ 0 ] * heightRatio + (1<<(Acc−1))) >> Acc
  for( i = 1; i < NumPartitionRowsAtt[ 0 ]; i++ ) {
    PartitionPosYAtt[attrIdx][ i ] = PartitionPosYAtt[attrIdx][ i − 1 ] +
      PartitionHeightAtt[attrIdx][ i − 1 ]
    PartitionHeightAtt[attrIdx][ i ] =
      (partitionHeightAtt[ 0 ][ i ] * heightRatio + (1<<(Acc−1))) >> Acc
  }
}
```

By using integer division, completely the same operation can be easily secured in all of the implementations. By increasing accuracy of Acc, a decimal ratio can also be supported with accuracy. The amount of calculation can also be reduced.

### Variable Derivation Configuration Example 3

Alternatively, for the values of the syntax elements afati_partition_column_width_minus 1[attrIdx][i] and afati_partition_row_height_minus1[attrIdx][i], the extension information decoder 3023 may perform inference of syntax in a case that the syntax is not present as follows.

In a case that afati_partition_column_width_minus1[attrIdx][i] is not present, it is inferred as ((afati_partition_column_width_minus1[attrIdx][0]*widthRatio+(1<<(Acc−1)))>>Acc)−1. Here, widthRatio is derived as (asve_attribute_frame_width[attrIdx]<<Acc)+(asve_attribute_frame_width[0]>>1)/asve_attribute_frame_width[0].

In a case that afati_partition_row_height_minus 1[attrIdx][i] is not present, it is inferred as ((afati_partition_column_height_minus 1[attrIdx][0]*heightRatio+(1<<(Acc−1)))>>Acc)−1. Here, heightRatio is derived as (asve_attribute_frame_height[attrIdx]<<Acc)+(asve_attribute_frame_height[0]>>1)/asve_attribute_frame_height[0].

As described above, the same operation as variable derivation configuration example 2 can also be implemented using inference of syntax values.

In a case that the syntax element afati_single_partition_per_tile_flag[attrIdx] is not present, it is inferred as afti_single_partition_per_tile_flag, and in a case that the syntax element afati_num_tiles_in_atlas_frame_minus1[attrIdx] is not present, it is inferred as afti_num_tiles_in_atlas_frame_minus1.

Variable Derivation Configuration Example 4

Alternatively, in a case that the flag afve_consistent_tiling_across_attribute_video_flag is equal to 1, or the flag afati_consistent_tiling_across_atlas_and_attribute_flag[attrIdx] is equal to 1, the extension information decoder 3023 may perform the following attribute tile partition inference processing. In the processing, as described below, derivation is performed with shift operation using logarithm to base 2.

```
  for( attrIdx = 1; attrIdx < asve_num_attribute_video; attrIdx++ ) {
    if (afve_consistent_tiling_acros_attribute_video_flag ||
      !afati_consistent_tiling_across_atlas_and_attribute_flag[attrIdx]))
    widthShift = Ceil(Log2(asve_attribute_frame_width[attrIdx]÷asve_attribute_{—}
frame_width[ 0 ] )+Acc
    NumPartitionColumnsAtt[attrIdx] = NumPartitionColumnsAtt[ 0 ]
    PartitionPosXAtt[attrIdx][ 0 ] = 0
    partitionWidthAtt[attrIdx][ 0 ] =
      (partitionWidthAtt[ 0 ][ 0 ] << widthShift ) >> Acc
    for( i = 1; i < NumPartitionColumnsAtt[ 0 ]; i++ ) {
      PartitionPosXAtt[attrIdx][ i ] = PartitionPosXAtt[attrIdx][ i − 1 ] +
        PartitionWidthAtt[attrIdx][ i − 1 ]
      PartitionWidthAtt[attrIdx][ i ] =
        (partitionWidthAtt[ 0 ][ i ] << widthShift ) >> Acc
    }
    heightShift = Ceil(Log2(asve_attribute_frame_height[attrIdx]÷asve_attribut
e_frame_height[ 0 ] )+Acc
    NumPartitionRowsAtt[attrIdx] = NumPartitionRowsAtt[ 0 ]
    PartitionPosYAtt[attrIdx][ 0 ] = 0
      (partitionHeightAtt[ 0 ][ 0 ] << heightShift) >> Acc
    for( i = 1; i < NumPartitionRowsAtt[ 0 ]; i++ ) {
      PartitionPosYAtt[attrIdx][ i ] = PartitionPosYAtt[attrIdx][ i − 1 ] +
        PartitionHeightAtt[attrIdx][ i − 1 ]
      PartitionHeightAtt[attrIdx][ i ] =
        (partitionHeightAtt[ 0 ][ i ] << heightShift) >> Acc
    }
  }
```

Here, widthShift and heightShift are logarithm of 2 of a ratio of the width and the height of the tile of attrIdx=0 and the tile of the target attrIdx. Acc is added to avoid a negative value in shift operation. Other than Ceil, Floor and Round may be used.

Alternatively, the values of the syntax elements afati_partition_column_width_minus1[attrIdx][i] and afati_partition_row_height_minus1[attrIdx][i] may be inferred as follows.

In a case that afati_partition_column_width_minus1[attrIdx][i] is not present, it is inferred as afati_partition_column_width_minus 1[attrIdx][0]<<widthShift>>Acc.

In a case that afati_partition_row_height_minus1[attrIdx][i] is not present, it is inferred as afati_partition_column_height_minus1[attrIdx][0]<<heightRatio>>Acc.

According to the configuration, there is an effect that the amount of codes is reduced by encoding and decoding only differences between the atlas tile information and a part or all of the attribute tile information.

### Decoding of Base Mesh

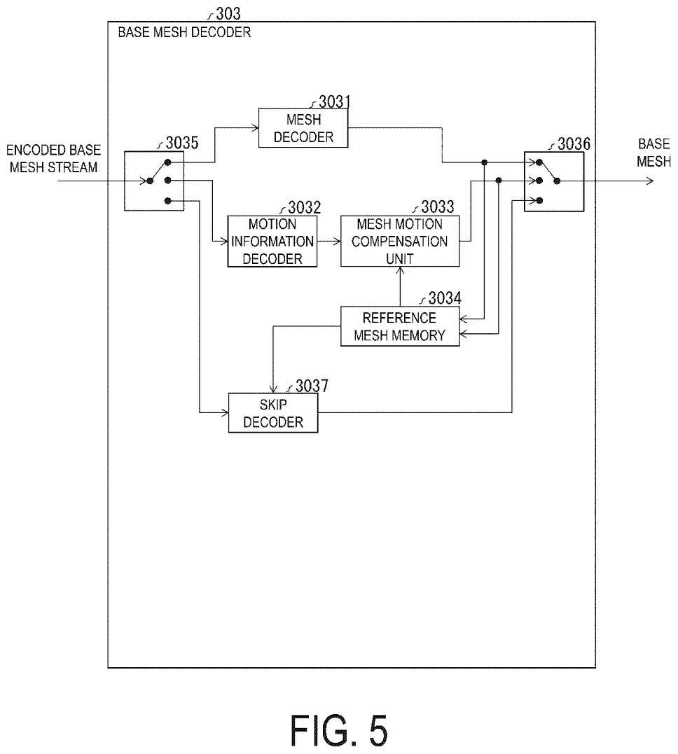

FIG. 5 is a functional block diagram illustrating a configuration of the base mesh decoder 303. The base mesh decoder 303 includes a mesh decoder 3031, a motion information decoder 3032, a mesh motion compensation unit 3033, a reference mesh memory 3034, a switch 3035, a switch 3036, and a skip decoder 3037. The base mesh decoder 303 may include a base mesh inverse quantization unit (not illustrated) prior to output of the base mesh. In a case that the target base mesh to be decoded is encoded (intra-encoded) without referring to another base mesh (for example, an already encoded and decoded base mesh), the switch 3035 and the switch 3036 are connected on the mesh decoder 3031 side. In contrast, in a case that the target base mesh to be decoded is encoded (inter-encoded) by referring to another base mesh, they are connected on the side to perform motion compensation. In a case that motion compensation is performed, the target vertex coordinates are derived by referring to already decoded vertex coordinates and motion information. In contrast, in a case that the target base mesh to be decoded is skipped and another base mesh is encoded (skip-encoded) as the target to be decoded, they are connected on the skip decoder 3037 side.

Each base mesh includes one or multiple submeshes. In a case that multiple submeshes are present, the tile header in an atlas data sub-bitstream requires an ID to search for a submesh corresponding to the tile. Here, the submesh is a subset of meshes defined by indicating a part of a three-dimensional model, and is a mesh obtained by dividing a mesh into multiple parts. By dividing meshes into a subset to finely control a part of the three-dimensional model, meshes in a specific range can be individually defined. Each submesh includes unique vertex coordinates, normal vectors, texture coordinates, and the like, and can be individually operated and edited. A mesh of a certain frame is referred to as a mesh frame.

The mesh decoder 3031 decodes an encoded base mesh stream that has been intra-encoded and outputs a base mesh (a base mesh vertex position, a base mesh vertex position vector). Draco, edge breaker, or the like is used as an encoding scheme.

The motion information decoder 3032 decodes an encoded base mesh stream that has been inter-encoded and outputs motion information (mesh motion information, a mesh motion vector) for each vertex of a reference mesh which will be described later. Entropy encoding such as arithmetic encoding is used as an encoding scheme.

The mesh motion compensation unit 3033 performs motion compensation on each vertex of the reference mesh received from the reference mesh memory 3034 based on the motion information and outputs a motion-compensated mesh.

The reference mesh memory 3034 is a memory that holds decoded meshes for reference in subsequent decoding processing.

### Decoding of Mesh Displacements

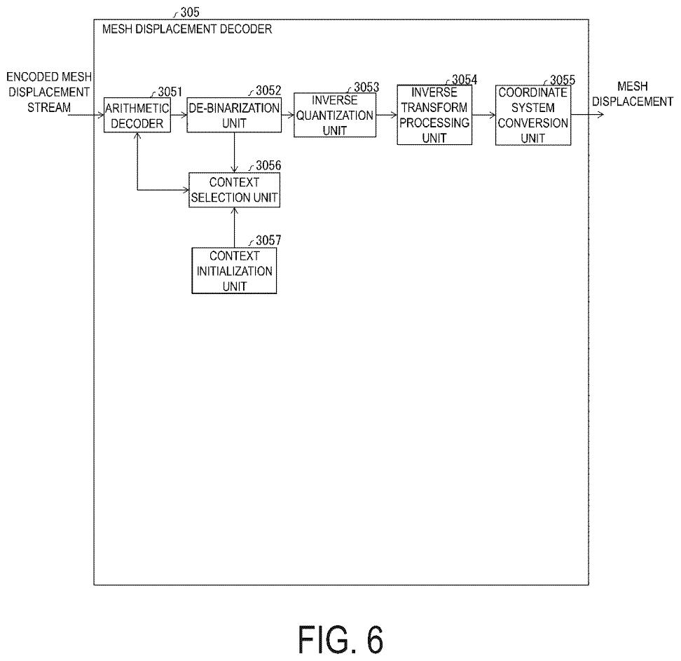

FIG. 6 is a functional block diagram illustrating a configuration of the mesh displacement decoder 305. The mesh displacement decoder 305 includes a CABAC decoder (an arithmetic decoder 3051, a de-binarization unit 3052, a context selection unit 3056, and a context initialization unit 3057), an inverse quantization unit 3053, an inverse transform processing unit 3054, and a coordinate system conversion unit 3055.

Coordinate Systems

The following two types of coordinate systems are used as coordinate systems for mesh displacements (three-dimensional vectors).

Cartesian coordinate system (canonical): An orthogonal coordinate system that is commonly defined throughout 3D space. An (X, Y, Z) coordinate system. An orthogonal coordinate system whose directions do not change at the same time (within the same frame or within the same tile).

Local coordinate system (local): An orthogonal coordinate system defined for each region or each vertex in 3D space. An orthogonal coordinate system whose directions can change at the same time (within the same frame or within the same tile). A coordinate system with a normal axis (D), a tangent axis (U), and a bi-tangent axis (V). That is, the local coordinate system is an orthogonal coordinate system that has a first axis (D) indicated by a normal vector n_vec at a certain vertex (on a surface including a certain vertex) and a second axis (U) and a third axis (V) indicated by two tangent vectors t_vec and b_vec orthogonal to the normal vector n_vec. n_vec, t_vec, and b_vec are three-dimensional vectors. The (D, U, V) coordinate system may also be referred to as an (n, t, b) coordinate system.

### Decoding and Derivation of Sequence-Level Control Parameters

Here, sequence-level control parameters to be decoded from encoded data in the mesh displacement decoder 305 will be described.

FIG. 8 is an example of syntax of ASPS Vdmc Extension (ASVE) being a sequence-level mesh data extension encoding parameter set. The ASPS is one of the NAL units of the atlas information, and includes syntax elements to be applied to an encoded atlas information stream. Semantics of each field is as follows.

asve_subdivision_iteration_count: it indicates the number of subdivision iterations of the mesh.

asve_displacement_coordinate_system: coordinate system conversion information indicating the coordinate system for mesh displacements. A value equal to a prescribed first value (for example, 0) indicates a Cartesian coordinate system. A value equal to a second value (for example, 1) different from the first value indicates a local coordinate system.

asve_ld_displacement_flag: flag indicating whether or not the mesh displacement is one-dimensional. The value being true indicates that the mesh displacement is one-dimensional. The value being false indicates that the mesh displacement is three-dimensional.

### Decoding and Derivation of Picture/Frame-Level Control Parameters

FIG. 9 is an example of syntax of extension encoding parameter information in the AFPS being a picture/frame-level parameter set. The AFPS is one of the NAL units of the atlas information, and includes syntax elements to be applied to an encoded atlas information stream. Semantics of each field is as follows. The AFPS includes atlas_frame_mesh_information().

afve_overriden_flag: flag indicating whether or not the coordinate system for mesh displacements is updated. In a case that the flag is equal to true, the coordinate system for mesh displacements is updated based on the value of afve_displacement_coordinate_system to be described later. In a case that the flag is equal to false, the coordinate system for mesh displacements is not updated.

afve_subdivision_iteration_count: it indicates the number of subdivision iterations of the mesh.

afve_displacement_coordinate_system: coordinate system conversion information indicating the coordinate system for mesh displacements. A value equal to a first value (for example, 0) indicates a Cartesian coordinate system. A value equal to a second value (for example, 1) indicates a local coordinate system. In a case that this syntax element is not present, the value is inferred to be a value decoded using the ASPS and a coordinate system indicated by the ASPS is set as a default coordinate system.

### Operation of Mesh Displacement Decoder

The arithmetic decoder 3051 decodes the mesh displacement encoding stream arithmetically encoded according to a value (context) indicating a random variable, and outputs a binary signal. The binary signal may be an alpha code, or may be a k-th order exponential Golomb code (k-th order Exp-Golomb-code). The exponential Golomb code includes prefix and suffix codes. The prefix is an exponentially increasing value and the suffix is its remainder. Note that, in a case that a variable rem is encoded and decoded using the exponential Golomb code, the prefix and the suffix of the exponential Golomb code are also referred to as the prefix and the suffix of rem.

The de-binarization unit 3052 decodes the binary signal to obtain a quantized mesh displacement Qdisp, which is a multi-valued signal.

The context selection unit 3056 (context memory) includes a memory for holding a context, derives a context used for arithmetic decoding of the mesh displacement depending on a state, and updates the value as necessary.

The context initialization unit 3057 initializes a context (probability of occurrence of a binary signal).

### Processing of Deriving Mesh Displacement

The mesh displacement decoder 305 decodes the syntax elements dismu_nz_subBlock, dismu_coeff_abs_level_gt0, dismu_coeff_abs_level_gt1, dismu_coeff_abs_level_gt2, dismu_coeff_abs_level_gt3, dismu_coeff_abs_level_rem, and dismu_coeff_sign to derive the mesh displacement Qdisp, by using the following processing.

The inverse quantization unit 3053 performs inverse quantization based on a quantization scale value iscale to derive a transformed (for example, wavelet-transformed) mesh displacement Tdisp. Tdisp may be a value in a Cartesian coordinate system or a local coordinate system. iscale is a value derived from the quantization parameter of each component of a mesh displacement image. Inverse quantization may be performed for each submesh indicated by subMeshID (=displSubMeshID).

$$Tdisp [ subMeshID ] [ 0 ] [ ] = ( Qdisp [ subMeshID ] [ 0 ] [ ] * iscale [ 0 ] + iscaleOffset ) ≫ iscaleShift$$

$$Tdisp [ subMeshID ] [ 1 ] [ ] = ( Qdisp [ subMeshID ] [ 1 ] [ ] * iscale [ 1 ] + iscaleOffset ) ≫ iscaleShift$$

$$Tdisp [ subMeshID ] [ 2 ] [ ] = ( Qdisp [ subMeshID ] [ 2 ] [ ] * iscale [ 2 ] + iscaleOffset ) ≫ iscaleShift$$

Here, iscaleOffset=1<<(iscaleShift−1). iscaleShift may be a predetermined constant, or may be a value encoded at a sequence level, a picture/frame level, a submesh level indicated by subMeshID (=displSubMeshID), a tile/patch level, or the like and decoded from encoded data.

The inverse transform processing unit 3054 performs an inverse transform g (for example, an inverse wavelet transform) and derives a mesh displacement d.

$$d [ 0 ] [ ] = g ( Tdisp [ subMeshID ] [ 0 ] [ ] )$$

$$d [ 1 ] [ ] = g ( Tdisp [ subMeshID ] [ 1 ] [ ] )$$

$$d [ 2 ] [ ] = g ( Tdisp [ subMeshID ] [ 2 ] [ ] )$$

The coordinate system conversion unit 3055 converts the mesh displacement (the coordinate system for mesh displacements) into a Cartesian coordinate system based on the value of coordinate system conversion information displacementCoordinateSystem. Specifically, in a case that displacementCoordinateSystem==1, the displacement in the local coordinate system is converted into the displacement in the Cartesian coordinate system. Here, d is a three-dimensional vector indicating a mesh displacement before coordinate system conversion. disp is a three-dimensional vector indicating a mesh displacement after coordinate system conversion and is a value in the Cartesian coordinate system. n_vec, t_vec, and b_vec are three-dimensional vectors (in the Cartesian coordinate system) corresponding to the axes of a local coordinate system of a target region or target vertex.

```
if (displacementCoordinateSystem == 0) {
  disp = d
} else if (displacementCoordinateSystem == 1){
  disp = d[0] * n_vec3 + d[1] * t_vec3 + d[2] * b_vec3
}
```

Here, n_vec3, t_vec3, and b_vec3 are three-dimensional vectors (in the Cartesian coordinate system) corresponding to the axes of a local coordinate system of a target region with reduced fluctuations. For example, vectors in the coordinate system used for decoding are derived from the previous coordinate system and the current coordinate system as follows.

$$n\_vec3 = ( w * n\_vec3 + ( WT - w ) * n\_vec ) ≫ wShift$$

$$t\_vec3 = ( w * t\_vec3 + ( WT - w ) * t\_vec ) ≫ wShift$$

$$b\_vec3 = ( w * b\_vec3 + ( WT - w ) * b\_vec ) ≫ wShift$$

Here, for example, wShift=2, 3, 4, WT=1<<wShift, and w=1. . . . WT−1. For example, in a case that w=3 and wShift=3, the coordinate system vector is derived as follows.

$$n\_vec3 = ( w * n\_vec3 + 5 * n\_vec ) ≫ 3$$

$$t\_vec3 = ( w * t\_vec3 + 5 * t\_vec ) ≫ 3$$

$$b\_vec3 = ( w * b\_vec3 + 5 * b\_vec ) ≫ 3$$

### Reconstruction of Mesh

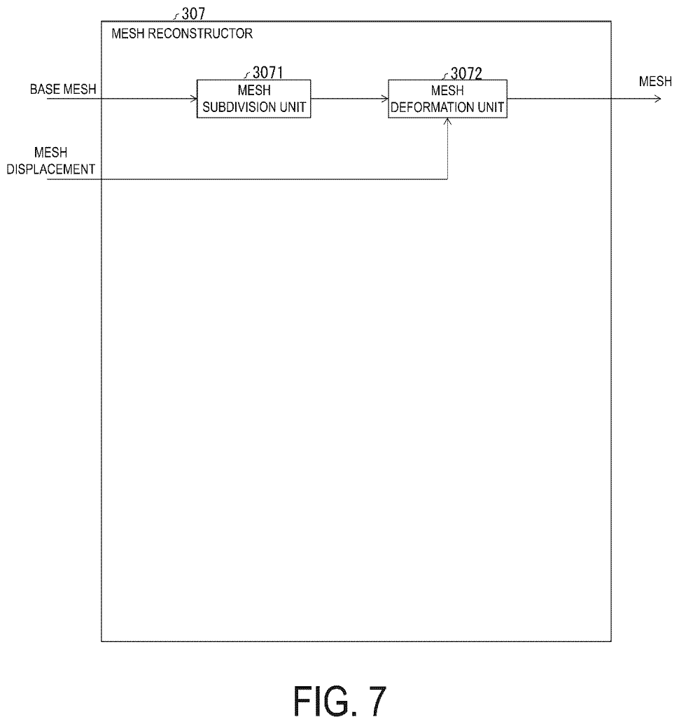

FIG. 7 is a functional block diagram illustrating a configuration of the mesh reconstructor 307. The mesh reconstructor 307 includes a mesh subdivision unit 3071 and a mesh deformation unit 3072.

The mesh subdivision unit 3071 subdivides a base mesh output from base mesh decoder 303 to generate a subdivided mesh.

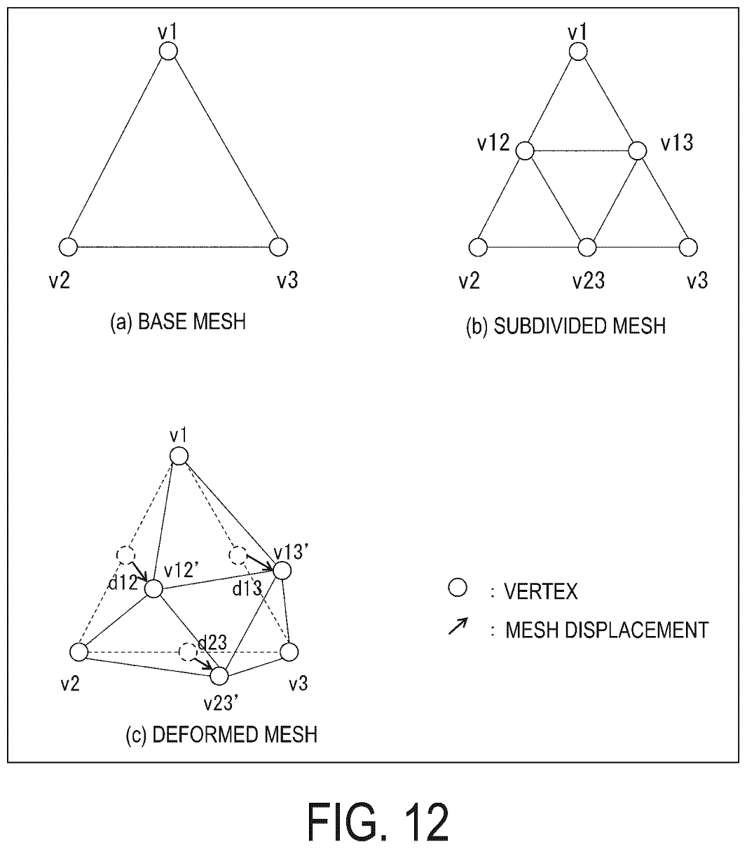

Part (a) of FIG. 12 illustrates a part (a triangle) of a base mesh and the triangle includes vertices v1, v2, and v3. v1, v2, and v3 are three-dimensional vectors. The mesh subdivision unit 3071 generates subdivided meshes by adding new vertices v12, v13, and v23 to the middle of the respective sides of the triangle, and outputs the subdivided meshes (Part (b) of FIG. 12).

$$v 12 = ( v 1 + v 2 ) / 2$$

$$v 13 = ( v 1 + v 3 ) / 2$$

$$v 23 = ( v 2 + v 3 ) / 2$$

The following may also be used.

$$v 12 = ( v 1 + v 2 + 1 ) ≫ 1$$

$$v 13 = ( v 1 + v 3 + 1 ) ≫ 1$$

$$v 23 = ( v 2 + v 3 + 1 ) ≫ 1$$

The mesh deformation unit 3072 receives the subdivided meshes and mesh displacements, generates a deformed mesh by adding the mesh displacements d12, d13, and d23, and outputs the deformed mesh (Part (c) of FIG. 12). The mesh displacements d12, d13, and d23 are the output of the mesh displacement decoder 305 (the coordinate system conversion unit 3055). The mesh displacements d12, d13, and d23 are mesh displacements corresponding to the vertices v12, v13, and v23 added by the mesh subdivision unit 3071.

$$v {12}^{′} = v 12 + d 12$$

$$v {13}^{′} = v 13 + d 13$$

$$v {23}^{′} = v 23 + d 23$$

Note that d12=disp[0][], d13=disp[1][], and d23=disp[3][] may be satisfied.

### Configuration of Tile Information Syntax

The atlas frame can be divided into units of one or more partitions, and tiles can include the units (partitions). Typical cases include the following:
The atlas frame is not divided, and the whole atlas frame is used as one tile (afti_single_tile_in_atlas_frame_flag==1).
The atlas frame is divided into multiple partitions, and one partition is used as one tile (afti_single_tile_in_atlas_frame_flag==0 and afti_single_partition_per_tile_flag==1).

-The atlas frame is divided into multiple partitions, and one or more horizontally and vertically consecutive partitions are used as one tile (afti_single_tile_in_atlas_frame_flag==0 and afti_single_partition_per_tile_flag==0).

Note that the atlas frame can be divided into tile partitions (hereinafter also referred to as partitions) of NumPartitionColumns*NumPartitionRows, and in a case of division, a case of division of the frame at equal intervals or a case of division in indicated units can be selected. NumPartitionColumns and NumPartitionRows represent the number of partition divisions in the horizontal direction and the vertical direction, respectively.

Note that the tile is not limited to the atlas frame, and may be an attribute, a geometry, a displacement, or a mesh. In other words, the following syntax elements and the bitstream conformance condition thereof can also be used for attribute, geometry, displacement, and mesh tiles.

FIG. 10 is a diagram of syntax indicating tile information. As the tile information, atlas_frame_tile_information() defined in the ISO/IEC 23090-5 V3C standard may be used.

The tile information decoder 3022 decodes the syntax element afti_single_tile_in_atlas_frame_flag. afti_single_tile_in_atlas_frame_flag is a binary flag indicating whether or not the atlas frame includes a single tile, and has a value (for example, 1) indicating that the atlas frame includes a single tile or a value (for example, 0) indicating that the atlas frame includes multiple tiles. In a case that the value of afti_single_tile_in_atlas_frame_flag is a value indicating multiple tiles, the tile information decoder 3022 decodes a syntax element afti_uniform_partition_spacing_flag. Here, afti_uniform_partition_spacing_flag is a binary flag indicating whether or not the atlas frame is divided into partitions at equal intervals, and has a value (for example, 1) indicating that the atlas frame is divided into partitions at equal intervals or a value (for example, 0) indicating that the atlas frame is divided into partitions at different intervals.

The tile information decoder 3022 derives a parameter indicating the position and the size of the tile.
Case that afti_uniform_partition_spacing_flag is a value indicating 1

The tile information decoder 3022 decodes syntax elements afti_partition_cols_width_minus1 and afti_partition_cols_width_minus1 indicating the width (column width) and the height (row height) of each partition except the rightmost column and the bottommost row. In each of i=0. NumPartitionColumns−1 and j=0. NumPartitionRows, PartitionPosX[i], PartitionPos Y[j], Partition Width[i], and PartitionHeight[j] indicating the x and y coordinates, the width, and the height of the top left of each partition are derived as follows.

```
partitionWidth = ( afti_partition_cols_width_minus1 + 1 ) * 64
NumPartitionColumns = asps_frame_width / partitionWidth
PartitionPosX[ 0 ] = 0
PartitionWidth[ 0 ] = partitionWidth
for( i = 1; i < NumPartitionColumns − 1; i++ ) {
  PartitionPosX[ i ] = PartitionPosX[ i − 1 ] + PartitionWidth[ i − 1 ]
  PartitionWidth[ i ] = partitionWidth
}
partitionHeight = (afti_partition_rows_height_minus1 + 1) * 64
NumPartitionRows = asps_frame_height / partitionHeight
PartitionPosY[ 0 ] = 0
PartitionHeight[ 0 ] = partitionHeight
for( j = 1; j < NumPartitionRows − 1; j++ ) {
  PartitionPosY[ j ] = PartitionPosY[ j − 1 ] + PartitionHeight[ j − 1 ]
  PartitionHeight[ j ] = partitionHeight
}
```

Case that afti_uniform_partition_spacing_flag is a value indicating 0

The tile information decoder 3022 decodes syntax elements afti_num_partition_columns_minus1 and afti_num_partition_rows_minus1 indicating the number of tile partitions in the horizontal direction and the height direction.

In each of i=0. . . . NumPartitionColumns−1 and j=0. NumPartitionRows, PartitionPosX[i], PartitionPos Y[j], Partition Width[i], and PartitionHeight[j] indicating the x and y coordinates, the width, and the height of the top left of each partition are derived as follows.

```
  NumPartitionColumns = afti_num_partition_columns_minus1 + 1
  PartitionPosX[ 0 ] = 0
  partitionWidth[ 0 ] = ( afti_partition_column_width_minus1[ 0 ] + 1 ) * 64
  for( i = 1; i < NumPartitionColumns − 1; i++ ) {
    PartitionPosX[ i ] = PartitionPosX[ i − 1 ] + PartitionWidth[ i − 1 ]
    PartitionWidth[ i ] = ( afti_partition_column_width_minus1[ i ] + 1 ) * 6
4
  }
  NumPartitionRows = afti_num_partition_rows_minus1 + 1
  PartitionPosY[ 0 ] = 0
  PartitionHeight[ 0 ] = ( afti_partition_row_height_minus1[ 0 ] + 1 ) * 64
  for( j = 1; j < NumPartitionRows − 1; j++ ) {
    PartitionPosY[ j ] = PartitionPosY[ j − 1 ] + PartitionHeight[ j − 1 ]
    PartitionHeight[ j ] = ( afti_partition_row_height_minus1[ j ] + 1 ) * 64
  }
```

In a case that the number of partitions in the horizontal direction and the height direction is equal to or greater than 2, PartitionPosX[i], PartitionPosY[j], Partition Width[i], and PartitionHeight[j] indicating the x and y coordinates, the width, and the height of the top left of each partition in the rightmost column and the bottommost row are derived as follows.

$$PartitionPosX [ NumPartitionColumns - 1 ] = PartitionPosX [ NumPartitionColumns - 2 ] + PartitionWidth [ NumPartitionColumns - 2 ]$$

$$PartitionWidth [ NumPartitionColumns - 1 ] = asps\_frame \_width - PartitionPosX [ NumPartitionColumns - 1 ]$$

$$PartitionPosY [ NumPartitionRows - 1 ] = PartitionPosY [ NumPartitionRows - 2 ] + partitionHeight [ NumPartitionRows - 2 ]$$

$$PartitionHeight [ NumPartitionRows - 1 ] = asps\_frame \_height - PartitionPosY [ NumPartitionRows - 1 ]$$

Here, the width and the height of each partition are set equal to a multiple of 64, but is not limited to 64, and 64 may be replaced by 32, 128, or 256.

The tile information decoder 3022 decodes the syntax element afti_single_partition_per_tile_flag. Here, afti_single_partition_per_tile_flag is a flag indicating whether or not each tile includes only a single partition, and has a value (for example, 1) indicating that each tile includes only a single partition or a value (for example, 0) indicating that each tile includes multiple partitions. In a case that afti_single_partition_per_tile_flag is a value indicating multiple partitions, the tile information decoder 3022 decodes the syntax element afti_num_tiles_in_atlas_frame_minus1, and performs the following processing of deriving parameters of tiles from one or more selected partitions. Here, afti_num_tiles_in_atlas_frame_minus1 is the number of tiles included in the atlas frame.

The tile information decoder 3022 decodes syntax elements afti_top_left_partition_idx[i], afti_bottom_right_partition_column_offset[i], and afti_bottom_right_partition_row_offset[i] with respect to each of i=0 afti_num_tiles_in_atlas_frame_minus1. Here, afti_top_left_partition_idx[i] is an index of a partition in which the top left edge (corner, point) of the i-th tile is located, afti_bottom_right_partition_column_offset[i] is the amount of offset in the horizontal direction of the bottom right edge of the i-th tile with respect to the top left edge of the i-th tile, and afti_bottom_right_partition_row_offset[i] is the amount of offset in the height direction of the bottom right edge of the i-th tile with respect to the top left edge of the i-th tile.

Based on the decoded syntax, indices topLeftColumn[i], topLeftRow[i], bottomRightColumn[i], and bottomRightRow[i] of the partitions on the top left in the horizontal direction and the height direction and on the bottom right in the horizontal direction and the height direction of each tile i are derived as follows.

$$topLeftColumn ( i ) = afti\_top \_left \_partition \_idx [ i ] \% NumPartitionColumns$$

$$topLeftRow ( i ) = afti\_top \_left \_partition \_idx [ i ] / NumPartitionColumns$$

$$bottomRightColumn ( i ) = topLeftColumn ( i ) + afti\_bottom \_right \_partition \_column \_offset [ i ]$$

$$bottomRightRow ( i ) = topLeftRow ( i ) + afti\_bottom \_right \_partition \_row \_offset [ i ]$$

Here, bottomRightColumn[i] and bottomRightRow[i] may be (asps_frame_width+63)/64−1 and (asps_frame_height+63)/64−1 or less, respectively.

The 3D data decoding apparatus 31 that decodes mesh data or point cloud data may include a component that decodes a syntax element indicating a position of a tile, and derives a column topLeftColumn in the top left partition and a row topLeftRow in the top left partition of the tile and a column bottomRightColumn in the bottom right partition and a row bottomRightRow in the bottom right partition of the tile, and the 3D data decoding apparatus 31 may decode a bitstream satisfying a specific bitstream conformance condition regarding the partition columns (topLeftColumn[i] and bottomRightColumn[i]) of the i-th tile, the partition column (topLeftColumn[j]) of the j-th tile, the partition rows (topLeftRow[i] and bottomRightRow[i]) of the i-th tile, and the partition row (topLeftRow[j]) of the j-th tile. The 3D data decoding apparatus 31 may decode the bitstream satisfying the following bitstream conformance condition.

### Bitstream Restriction 1

As the bitstream conformance, a case satisfying, for i and j (j!=i), both of the following properties shall not be included:

$$topLeftColumn [ i ] <= topLeftColumn [ j ] <= bottomRightColumn [ i ] ; and$$

$$topLeftRow [ i ] <= topLeftRow [ j ] <= bottomRightRow [ i ] .$$

In the restriction, there is an effect that overlapping of different tiles is forestalled. The decoding apparatus does not decode a bitstream in which different tiles overlap, and therefore complexity is reduced.

The encoding apparatus generates a bitstream by configuring tiles to satisfy neither of the conditions with respect to different tiles i and j.

### Bitstream Restriction 2

As another configuration, as the bitstream conformance, a case satisfying, for i and j (j!=i), one of the following properties shall not be included:

$$topLeftColumn [ i ] <= topLeftColumn [ j ] <= bottomRightColumn [ i ] ; and$$

$$topLeftRow [ i ] <= topLeftRow [ j ] <= bottomRightRow [ i ] .$$

In the configuration, topLeftColumn[i]<=topLeftColumn[j]<=bottomRightColumn[i] is satisfied, and topLeftRow[i]<=topLeftRow[j]<=bottomRightRow[i] is not satisfied. Because one of them is satisfied, this disagrees with the bitstream condition. In other words, an example in which the positions of boundaries of the tiles being alternated in the frame is prohibited.

### Bitstream Restriction 3

As another configuration, as the bitstream conformance, a case satisfying, for i and j (j!=i), one or both of the following properties shall not be included:

$$topLeftColumn [ i ] <= topLeftColumn [ j ] <= bottomRightColumn [ i ] ; and$$

$$topLeftRow [ i ] <= topLeftRow [ j ] <= bottomRightRow [ i ] .$$

The following expression representing a similar restriction may be used. As the bitstream conformance, a case satisfying, for i and j (j!=i), one or more of the following properties shall not be included:

$$topLeftColumn [ i ] <= topLeftColumn [ j ] <= bottomRightColumn [ i ] ; and$$

$$topLeftRow [ i ] <= topLeftRow [ j ] <= bottomRightRow [ i ] .$$

The restriction may also be used as the bitstream configuration in a case that the codec is HEVC.

### Bitstream Restriction 4

As another configuration, as the bitstream conformance, a case satisfying, for i and j (j!=i), the following property shall not be included:

$$topLeftColumn [ i ] <= topLeftColumn [ j ] <= bottomRightColumn [ i ] .$$

The configuration does not allow slice divisions, which are allowed in VVC slice divisions, to be alternated in the horizontal direction, but allows slice divisions to be alternated in the vertical direction. The restriction may also be used as the bitstream configuration in a case that the codec is VVC.

### Configuration for Each Codec

Depending on a type of video codec to be used, the bitstream condition may be changed. For example, for AVC and HEVC, bitstream restriction 3 may be used, and for VVC, bitstream restriction 4 may be used. As described above, the type of the codec may be determined using one of ptl_profile_codec_group_idc obtained by decoding the V3C parameter set of encoded data, gi_attribute_codec_id[atlasID] of the V3C parameter set, bmsps_intra_mesh_codec_id of the base mesh, bmsps_inter_mesh_codec_id, and dsps_codec_id of the displacement.

In other words, the 3D data decoding apparatus further decodes a syntax element indicating the codec, and in a case that the codec is AVC or HEVC, the bitstream conformance is as follows:

$$topLeftColumn [ i ] <= topLeftColumn [ j ] <= bottomRightColumn [ i ]$$

$$topLeftRow [ i ] <= topLeftRow [ j ] <= bottomRightRow [ i ]$$

The bitstream conformance with the codec being VVC is topLeftColumn[i]<=topLeftColumn[j]<=bottomRightColumn[i].

### Configuration of 3D Data Encoding Apparatus According to First Embodiment

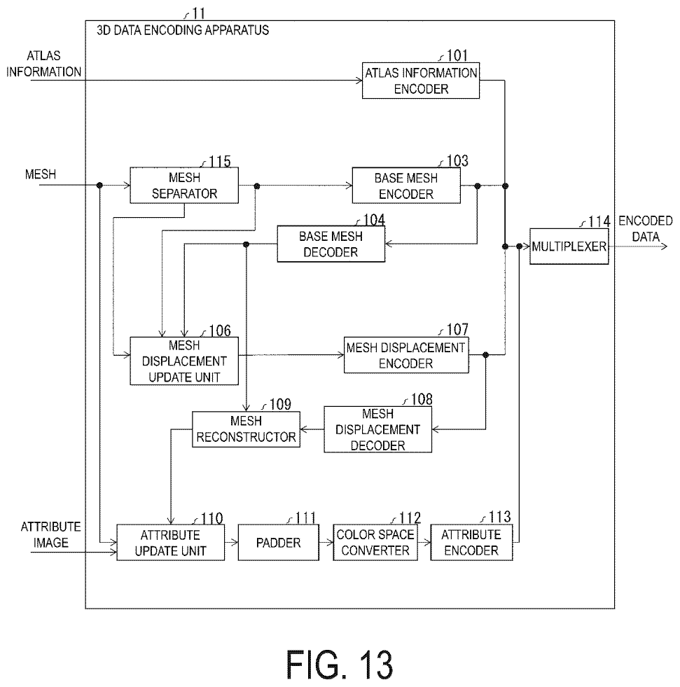

FIG. 13 is a functional block diagram illustrating a schematic configuration of the 3D data encoding apparatus 11 according to the first embodiment. The 3D data encoding apparatus 11 includes an atlas information encoder 101, a base mesh encoder 103, a base mesh decoder 104, a mesh displacement update unit 106, a mesh displacement encoder 107, a mesh displacement decoder 108, a mesh reconstructor 109, an attribute update unit 110, a padder 111, a color space converter 112, an attribute encoder 113, a multiplexer 114, and a mesh separator 115. The 3D data encoding apparatus 11 receives atlas information, a base mesh, mesh displacements, a mesh, and attribute image as 3D data and outputs encoded data.

The atlas information encoder 101 encodes the atlas information and outputs an encoded atlas information stream.

The base mesh encoder 103 encodes the base mesh and outputs an encoded base mesh stream. Draco or the like is used as an encoding scheme.

The base mesh decoder 104 is similar to the base mesh decoder 303 and thus description thereof will be omitted.

The mesh displacement update unit 106 adjusts the mesh displacements based on the (original) base mesh and the decoded base mesh and outputs the updated mesh displacement.

The mesh displacement encoder 107 encodes the updated mesh displacements and outputs an encoded mesh displacement stream.

The mesh displacement decoder 108 is similar to the mesh displacement decoder 305 and thus description thereof will be omitted.

The mesh reconstructor 109 is similar to the mesh reconstructor 307 and thus description thereof will be omitted.

The attribute update unit 110 receives the (original) mesh, the reconstructed mesh output from the mesh reconstructor 109 (the mesh deformation unit 3072), and the attribute image and updates the attribute image to match the positions (coordinates) of the reconstructed mesh and outputs the updated attribute image.

The padder 111 receives the attribute image and performs padding processing on an area where pixel values are empty.

The color space converter 112 performs color space conversion from an RGB format to a YCbCr format.

The attribute encoder 113 encodes the YCbCr-format attribute image output from the color space converter 112 and outputs an attribute video stream. VVC, HEVC, or the like is used as an encoding scheme.

The multiplexer 114 multiplexes the encoded atlas information stream, the encoded base mesh stream, the encoded mesh displacement stream, and the attribute video stream and outputs the multiplexed data as encoded data. A byte stream format, the ISOBMFF, or the like is used as a multiplexing method.

### Operation of Mesh Separator

The mesh separator 115 generates a base mesh and mesh displacements from a mesh.

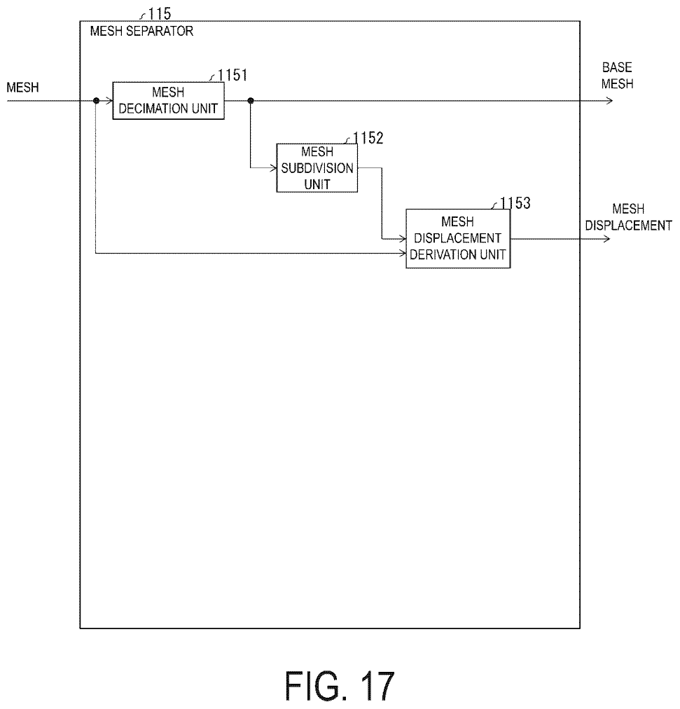

FIG. 17 is a functional block diagram illustrating a configuration of the mesh separator 115. The mesh separator 115 includes a mesh decimation unit 1151, a mesh subdivision unit 1152, and a mesh displacement derivation unit 1153.

The mesh decimation unit 1151 generates a base mesh by removing some vertices from the mesh.

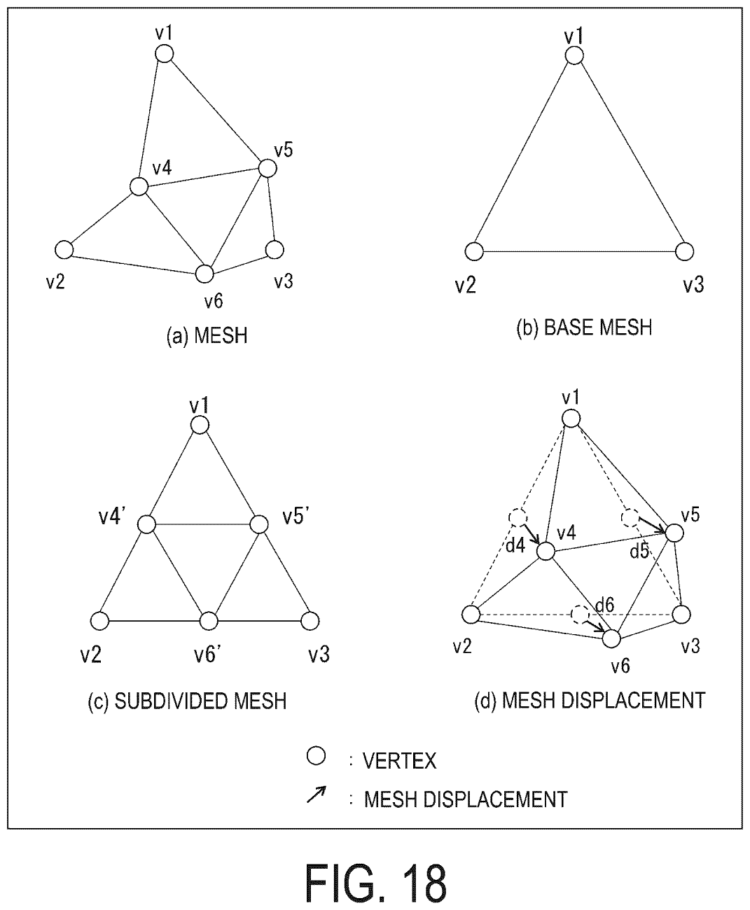

Part (a) of FIG. 18 illustrates a part of a mesh, and the mesh includes vertices v1, v2, v3, v4, v5, and v6. v1, v2, v3, v4, v5, and v6 are three-dimensional vectors. The mesh decimation unit 1151 generates a base mesh by decimating the vertices v4, v5, and v6, and outputs the base mesh (Part (b) of FIG. 18).

Like the mesh subdivision unit 3071, the mesh subdivision unit 1152 subdivides the base mesh to generate a subdivided mesh (Part (c) of FIG. 18).

$$v {4}^{′} = ( v 1 + v 2 ) / 2$$

$$v {5}^{′} = ( v 1 + v 3 ) / 2$$

$$v {6}^{′} = ( v 2 + v 3 ) / 2$$

Based on the mesh and the subdivided mesh, the mesh displacement derivation unit derives, as mesh displacements, displacements d4, d5, and d6 of the vertices v4, v5, and v6 with respect to the vertices v4′, v5′, and v6′ and outputs the displacements d4, d5, and d6 (Part (d) of FIG. 18).

$$d 4 = v 4 - v {4}^{′}$$

$$d 5 = v 5 - v {5}^{′}$$

$$d 6 = v 6 - v {6}^{′}$$

### Encoding of Atlas Information

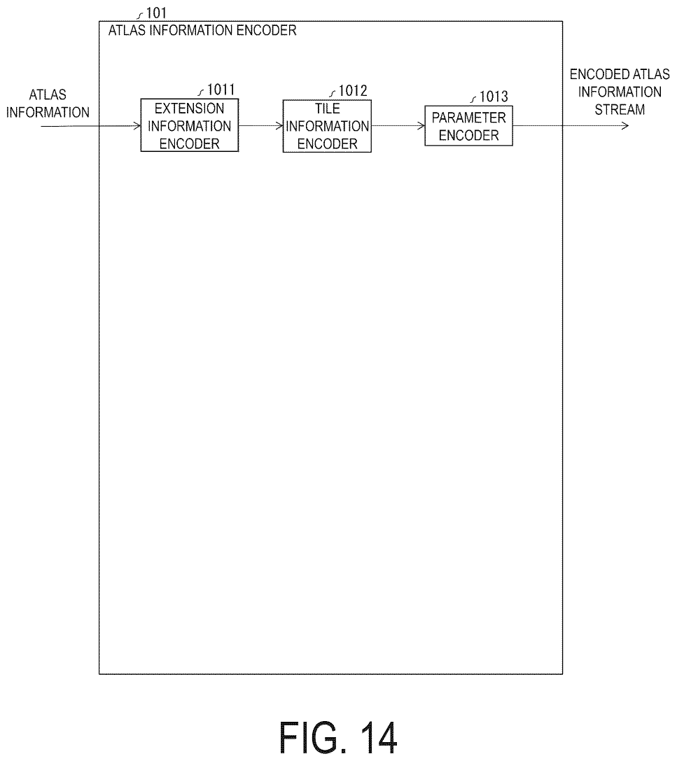

FIG. 14 is a functional block diagram illustrating a configuration of the atlas information encoder 101. The atlas information encoder 101 includes an extension information encoder 1011, a tile information encoder 1012, and a parameter encoder 1013.

The extension information encoder 1011 encodes extension encoding parameters related to mesh data.

The tile information encoder 1012 encodes the number of tiles and the tile IDs referred to at the picture/frame level.

The parameter encoder 1015 encodes encoding parameters related to 3D data.

### Encoding of Base Mesh

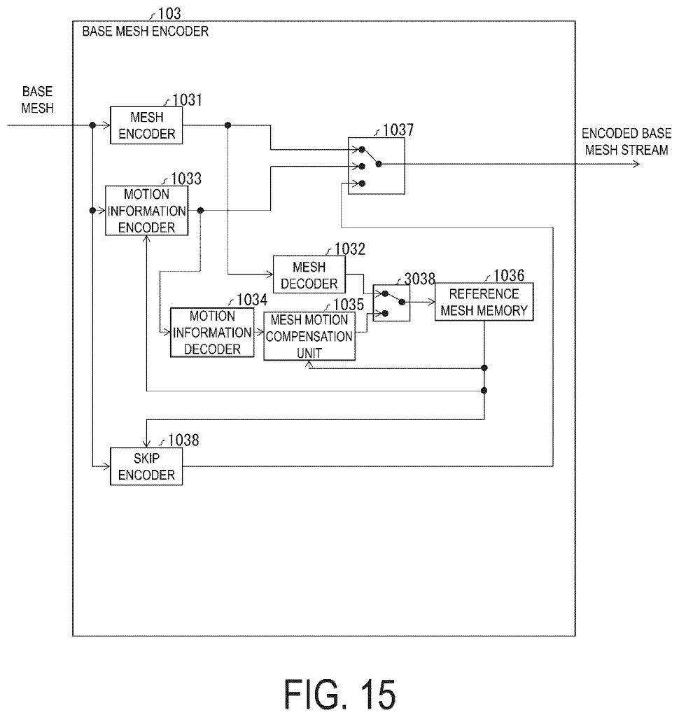

FIG. 15 is a functional block diagram illustrating a configuration of the base mesh encoder 103. The base mesh encoder 103 includes a mesh encoder 1031, a mesh decoder 1032, a motion information encoder 1033, a motion information decoder 1034, a mesh motion compensation unit 1035, a reference mesh memory 1036, a switch 1037, and a switch 1038. The base mesh encoder 103 may include a base mesh quantization unit (not illustrated) after the input of a base mesh. Each of the switches 1037 and 1038 is connected to the side where no motion compensation is performed in a case that the base mesh is to be encoded (intra-encoded) without reference to other base meshes (for example, base meshes that have already been encoded). On the other hand, each of the switches 1037 and 1038 is connected to the side where motion compensation is performed in a case that the base mesh is to be encoded (inter-encoded) with reference to another base mesh.

The mesh encoder 1031 has an intra encoding function and intra-encodes the base mesh, and outputs an encoded base mesh stream. Draco or the like is used as an encoding scheme.

The mesh decoder 1032 is similar to the mesh decoder 3031 and thus description thereof will be omitted.

The motion information encoder 1033 has an inter-encoding function and inter-encodes the base mesh and outputs an encoded base mesh stream. Entropy encoding such as arithmetic encoding is used as an encoding scheme.

The motion information decoder 1034 is similar to the motion information decoder 3032 and thus description thereof will be omitted.

The mesh motion compensation unit 1035 is similar to the mesh motion compensation unit 3033 and thus description thereof will be omitted.

The reference mesh memory 1036 is similar to the reference mesh memory 3034 and thus description thereof will be omitted.

Although embodiments of the present invention have been described above in detail with reference to the drawings, the specific configurations thereof are not limited to those described above and various design changes or the like can be made without departing from the spirit of the invention.

### Application Example

The 3D data encoding apparatus 11 and the 3D data decoding apparatus 31 described above can be used by being installed in various apparatuses that transmit, receive, record, and reproduce 3D data. Note that the 3D data may be natural 3D data captured by a camera or the like or may be artificial 3D data (including CG and GUI) generated by a computer or the like.

An embodiment of the present invention is not limited to the embodiments described above and various changes can be made within the scope indicated by the claims. That is, embodiments obtained by combining technical means appropriately modified within the scope indicated by the claims are also included in the technical scope of the present invention.

### INDUSTRIAL APPLICABILITY

Embodiments of the present invention are suitably applicable to a 3D data decoding apparatus that decodes encoded data into which 3D data has been encoded and a 3D data encoding apparatus that generates encoded data into which 3D data has been encoded. Embodiments of the present invention are also suitably applicable to a data structure for encoded data generated by a 3D data encoding apparatus and referenced by a 3D data decoding apparatus.

### REFERENCE SIGNS LIST

11 3D data encoding apparatus
101 Atlas information encoder
1011 Extension information encoder
1012 Tile information encoder
1013 Parameter encoder
103 Base mesh encoder
1031 Mesh encoder
1032 Mesh decoder
1033 Motion information encoder
1034 Motion information decoder
1035 Mesh motion compensation unit
1036 Reference mesh memory
1037 Switch
1038 Switch
1039 Skip encoding
104 Base mesh decoder
106 Mesh displacement update unit
107 Mesh displacement encoder
1071 Coordinate system conversion unit
1072 Transform processing unit
1073 Quantization unit
1074 Binarization unit
1075 Arithmetic encoder
1076 Context selection unit
1077 Context initialization unit
108 Mesh displacement decoder
109 Mesh reconstructor
110 Attribute update unit
111 Padder
112 Color space converter
113 Attribute encoder
114 Multiplexer
115 Mesh separator
1151 Mesh decimation unit
1152 Mesh subdivision unit
1153 Mesh displacement derivation unit
21 Network
31 3D data decoding apparatus
301 Demultiplexer
302 Atlas information decoder
3021 Parameter decoder
3022 Tile information decoder
3023 Extension information decoder
303 Base mesh decoder
3031 Mesh decoder
3032 Motion information decoder
3033 Mesh motion compensation unit
3034 Reference mesh memory
3035 Switch
3036 Switch
3037 Skip decoder
305 Mesh displacement decoder
3051 Arithmetic decoder
3052 De-binarization unit
3053 Inverse quantization unit
3054 Inverse transform processing unit
3055 Coordinate system conversion unit
307 Mesh reconstructor
306 Attribute decoder
3071 Mesh subdivision unit
3072 Mesh deformation unit
308 Color space converter
41 3D data display apparatus

1. A 3D data decoding apparatus for decoding mesh data or point cloud data, the 3D data decoding apparatus comprising:
a tile information decoder configured to decode atlas tile information from encoded data in which the mesh data or the point cloud data is encoded; and
an extension information decoder configured to decode extension control parameter information from the encoded data, wherein
the extension control parameter information includes attribute tile information, and
at the extension information decoder, a flag indicating a similarity/difference between the atlas tile information and the attribute tile information is decoded from the encoded data, and the attribute tile information is derived.

2. The 3D data decoding apparatus according to claim 1, wherein
the extension control parameter information includes a flag indicating whether or not the atlas tile information and the attribute tile information are consistent, and
at the extension information decoder, a first value is decoded in a case that the atlas tile information and the attribute tile information are consistent and otherwise a second value is decoded, and the atlas tile information and the attribute tile information are derived.

3. The 3D data decoding apparatus according to claim 1, wherein
the extension control parameter information includes a flag indicating whether or not the attribute tile information is consistent between all attributes, and
at the extension information decoder, a first value is decoded in a case that all of the attribute tile information is consistent and otherwise a second value is decoded, and in a case of the first value, only a first attribute tile information is derived, and for another attribute tile information, the attribute tile information is derived by duplicating the first attribute tile information.

4. The 3D data decoding apparatus according to claim 1, wherein
the attribute tile information includes a flag indicating whether or not the atlas tile information and a part or all of the attribute tile information are consistent, and
at the extension information decoder, a first value is decoded in a case that the atlas tile information and the part or all of the attribute tile information are consistent and otherwise a second value is decoded, and the atlas tile information and the attribute tile information are derived.

5. The 3D data decoding apparatus according to claim 1, wherein
the extension information decoder includes a component configured to decode a syntax element indicating a position of an attribute tile, and derive a column topLeftColumn in a top left partition and a row topLeftRow in the top left partition of the attribute tile and a column bottomRightColumn in a bottom right partition and a row bottomRightRow in the bottom right partition of the attribute tile, and
the extension information decoder decodes, in an index attrIdx, a bitstream satisfying a specific bitstream conformance condition regarding partition columns (topLeftColumn[attrIdx][i] and bottomRightColumn[attrIdx][i]) of an i-th attribute tile, a partition column (topLeftColumn[attrIdx][j]) of a j-th attribute tile, partition rows (topLeftRow[attrIdx][i] and bottomRightRow[attrIDx][i]) of the i-th attribute tile, and a partition row (topLeftRow[attrIdx][j]) of the j-th attribute tile.

6. The 3D data decoding apparatus according to claim 5, wherein
as the specific bitstream conformance condition, a case satisfying, for i and j (j!=i), both of following properties shall not be included:
topLeftColumn[attrIdx][i]<=topLeftColumn[attrIdx][j]<=bottomRightColumn[attrIdx][i]; and
topLeftRow[attrIdx][i]<=topLeftRow[attrIdx][j]<=bottomRightRow[attrIdx][i].

7. The 3D data decoding apparatus according to claim 5, wherein
as the specific bitstream conformance condition, a case satisfying, for i and j (j!=i), one or both of following properties shall not be included:
topLeftColumn[attrIdx][i]<=topLeftColumn[attrIdx][j]<=bottomRightColumn[attrIdx][i]; and
topLeftRow[attrIdx][i]<=topLeftRow[attrIdx][j]<=bottomRightRow[attrIdx][i].

8. The 3D data decoding apparatus according to claim 5, wherein
as the specific bitstream conformance condition, a case satisfying, for i and j (j!=i), one or more of following properties shall not be included:
topLeftColumn[attrIdx][i]<=topLeftColumn[attrIdx][j]<=bottomRightColumn[attrIdx][i]; and
topLeftRow[attrIdx][i]<=topLeftRow[attrIdx][j]<=bottomRightRow[attrIdx][i].

9. The 3D data decoding apparatus according to claim 5, wherein
as the specific bitstream conformance condition, a case satisfying, for i and j (j!=i), a following property shall not be included:
topLeftColumn[attrIdx][i]<=topLeftColumn[attrIdx][j]<=bottomRightColumn[attrIdx][i].

10. The 3D data decoding apparatus according to claim 5, wherein
the 3D data decoding apparatus further decodes a syntax element indicating a codec,
in a case that the codec is AVC or HEVC, the specific bitstream conformance condition is as follows:
topLeftColumn[attrIdx][i]<=topLeftColumn[attrIdx][j]<=bottomRightColumn[attrIdx][i]
topLeftRow[attrIdx][i]<=topLeftRow[attrIdx][j]<=bottomRightRow[attrIdx][i], and
the specific bitstream conformance condition with the codec being VVC is topLeftColumn[attrIdx][i]<=topLeftColumn[attrIdx][j]<=bottomRightColumn[attrIdx][i].

11. A 3D data encoding apparatus for encoding mesh data or point cloud data, the 3D data encoding apparatus comprising:
an extension information encoder configured to encode extension control parameter information; and
a tile information encoder configured to encode atlas tile information, wherein
the extension control parameter information includes attribute tile information, and
a flag indicating a similarity/difference between the atlas tile information and the attribute tile information encoded in the extension information encoder is encoded.

12. The 3D data encoding apparatus according to claim 11, wherein
the extension control parameter information includes a flag indicating whether or not the atlas tile information and the attribute tile information are consistent, and
at the extension information encoder, a first value is encoded in a case that the atlas tile information and the attribute tile information are consistent and otherwise a second value is encoded.

13. The 3D data encoding apparatus according to claim 11, wherein
the extension control parameter information includes a flag indicating whether or not the attribute tile information is consistent between all attributes, and
at the attribute tile information encoder, a first value is encoded in a case that the attribute tile information is consistent and otherwise a second value is encoded.

14. The 3D data encoding apparatus according to claim 11, wherein
the attribute tile information includes a flag indicating whether or not the atlas tile information and a part or all of the attribute tile information are consistent, and
at the extension information decoder, a first value is encoded in a case that the atlas tile information and the part or all of the attribute tile information are consistent and otherwise a second value is encoded.

15. The 3D data encoding apparatus according to claim 11, wherein
the extension information encoder includes a component configured to encode a syntax element indicating a position of an attribute tile, and derive a column topLeftColumn in a top left partition and a row topLeftRow in the top left partition of the attribute tile and a column bottomRightColumn in a bottom right partition and a row bottomRightRow in the bottom right partition of the attribute tile, and
the extension information encoder encodes, in an index attrIdx, a bitstream satisfying a specific bitstream conformance condition regarding partition columns (topLeftColumn[attrIdx][i] and bottomRightColumn[attrIdx][i]) of an i-th attribute tile, a partition column (topLeftColumn[attrIdx][j]) of a j-th attribute tile, partition rows (topLeftRow[attrIdx][i] and bottomRightRow[attrIDx][i]) of the i-th attribute tile, and a partition row (topLeftRow[attrIdx][j]) of the j-th attribute tile.
